(19) United States
(12) Patent Application Publication
(10) Pub. No.: US 2026/0330426 A1
(43) Pub. Date: Oct. 22, 2026

(54) PREDICTIVE MAINTENANCE DEVICE AND PREDICTIVE MAINTENANCE METHOD

(71) Applicant: ANRITSU CORPORATION, Kanagawa (JP)

(72) Inventors: Vlesie Mae SALAS, Kanagawa (JP); Mitsuo TAKAYANAGI, Kanagawa (JP); Tatsuki KOMATSUBARA, Kanagawa (JP)

(21) Appl. No.: 19/466,659

(22) Filed: Feb. 2, 2026

(30) Foreign Application Priority Data
Feb. 7, 2025 (JP) 2025-019576

(51) Int. Cl. G06Q 10/20

(52) U.S. Cl. CPC G06Q 10/20

(57) ABSTRACT

A predictive maintenance device includes: a time waveform data acquisition unit that acquires time waveform data of a target unit to be monitored, which is measured by a measurement circuit; an FFT unit that obtains a spectrum of the time waveform data; a disturbance removal unit that obtains a disturbance-removed waveform by removing an effect of a disturbance from the spectrum, a logarithmic spectrum, a cepstrum of the logarithmic spectrum, or a logarithmic cepstrum; a histogram creation unit that creates a histogram of power or an amplitude of the disturbance-removed waveform; a chi-square goodness-of-fit test processing unit that calculates a χ² value between the histogram obtained from an inspection product that is the target unit and the histogram obtained from a normal product; and an abnormality determination unit that determines whether or not the inspection product is abnormal based on a P value corresponding to the χ² value.

### TECHNICAL FIELD

The present invention relates to a predictive maintenance device and a predictive maintenance method, and particularly to a predictive maintenance device and a predictive maintenance method that can perform predictive maintenance of various components constituting an article inspection apparatus.

### BACKGROUND ART

In the related art, as failure maintenance of an article inspection apparatus, a repair form of any one of post-maintenance of various components replacing constituting the article inspection apparatus after a failure of a component or a preventive-maintenance of periodically replacing the component before the failure of the component has been used. Recently, in order to improve line productivity and reduce running costs, predictive maintenance for detecting an abnormal component in advance and replacing the component before a failure stoppage is required.

As a technology related to the predictive maintenance, for example, technologies disclosed in Patent Document 1 to Patent Document 3 are known. The technology of Patent Document 1 extracts a feature amount in units of frames from sensor data, and determines whether the extracted feature amount in units of frames is normal or abnormal by using normal class data as a discriminator.

The technology of Patent Document 2 detects waveform data such as vibration or sound generated during rotation of a rotating device, measures a temporal change of a spectrum of the waveform data by using short-time Fourier transform or wavelet transform, and performs abnormality determination based on a feature amount obtained from the temporal change of the spectrum of the waveform data. The feature amount here is a time interval (period) in which a frequency of a power peak of the spectrum or a cepstrum and power at the frequency exceed a threshold value set in advance.

The technology of Patent Document 3 performs abnormality detection by using a Mahalanobis distance based on data collected by using various types of sensors, and performs deterioration diagnosis or analysis.

### RELATED ART DOCUMENT

### Patent Document

[Patent Document 1] JP-A-2017-102765
[Patent Document 2] JP-A-1998-274558
[Patent Document 3] JP-A-2000-259222

### DISCLOSURE OF THE INVENTION

### Problem that the Invention is to Solve

However, in the technologies disclosed in Patent Document 1 to Patent Document 3 in the related art, there is a problem that it is difficult to detect an abnormality with high accuracy in a case where measurement data is not stable due to a change in a use environment caused by a disturbance effect such as a change in temperature and humidity.

The present invention has been made in order to solve such a problem in the related art, and an object of the present invention is to provide a predictive maintenance device and a predictive maintenance method capable of detecting an abnormality sign of a target unit to be monitored with high accuracy.

### Means for Solving the Problem

In order to solve the problem described above, according to a first aspect of the present invention, there is provided a predictive maintenance device that detects an abnormality sign of a target unit to be monitored forming a part of an apparatus, the predictive maintenance device including: a measurement circuit that measures a current or a voltage of the target unit during operation; a time waveform data acquisition unit that acquires time waveform data of the current or the voltage measured by the measurement circuit; an FFT unit that performs Fourier transform on the time waveform data to obtain a spectrum of the time waveform data; a disturbance removal unit that obtains a disturbance-removed waveform by removing an effect of a disturbance from any of the spectrum, a logarithmic spectrum of the spectrum, a cepstrum of the logarithmic spectrum, and a logarithmic cepstrum of the cepstrum; a histogram creation unit that creates a histogram of power or an amplitude of the disturbance-removed waveform; a chi-square goodness-of-fit test processing unit that calculates a chi-square goodness-of-fit test statistic between the histogram obtained from an inspection product that is the target unit having a possibility of an abnormality and the histogram obtained from a normal product that is the normal target unit; and an abnormality determination unit that determines whether or not the target unit as the inspection product is abnormal based on a P value corresponding to the chi-square goodness-of-fit test statistic.

With this configuration, the predictive maintenance device according to the first aspect of the present invention can clearly capture a change in a shape of the disturbance-removed waveform of the inspection product, and thus can detect the abnormality sign of the target unit with high accuracy. Therefore, with the predictive maintenance device according to the present invention, it is possible to replace the target unit with a new product at an appropriate time before the target unit fails, and it is possible to significantly reduce a downtime of an article inspection apparatus including the target unit.

Further, since the predictive maintenance device according to the first aspect of the present invention can mainly remove the disturbance effect caused by the change in the use environment inside and outside the target unit, the predictive maintenance can be performed immediately after the target unit is started to be operated.

According to a second aspect of the present invention, the predictive maintenance device according to the first aspect, further includes: a section division unit that calculates a plurality of peak frequencies or peak times of a plurality of quefrencies according to an operation state of the target unit in the disturbance-removed waveform, and divides the disturbance-removed waveform with a plurality of frequency sections or a plurality of time sections each including each of the peak frequencies or each of the peak times, in which the histogram creation unit creates the histogram of the disturbance-removed waveform for each of the frequency sections or the time sections.

With this configuration, the predictive maintenance device according to the second aspect of the present invention can detect a small change in the disturbance-removed waveform by reducing the number of pieces of data to be processed in a case of creating the histogram of the disturbance-removed waveform.

According to a third aspect of the present invention, in the predictive maintenance device according to the first aspect, the disturbance removal unit obtains the disturbance-removed waveform by dividing a value of power or an amplitude of the spectrum by an integral value related to a frequency of the spectrum. In addition, according to a fourth aspect of the present invention, in the predictive maintenance device according to the second aspect, the disturbance removal unit obtains the disturbance-removed waveform by dividing a value of power or an amplitude of the spectrum by an integral value related to a frequency of the spectrum.

According to a fifth aspect of the present invention, in the predictive maintenance device according to the first aspect, the disturbance removal unit obtains the disturbance-removed waveform by dividing a value of power or an amplitude of the cepstrum by an integral value related to a time of the cepstrum. In addition, according to a sixth aspect of the present invention, in the predictive maintenance device according to the second aspect, the disturbance removal unit obtains the disturbance-removed waveform by dividing a value of power or an amplitude of the cepstrum by an integral value related to a time of the cepstrum.

According to a seventh aspect of the present invention, in the predictive maintenance device according to the first aspect, the disturbance removal unit obtains the disturbance-removed waveform by subtracting a direct current component corresponding to a 0-th component of the cepstrum from the logarithmic spectrum. In addition, according to an eighth aspect of the present invention, in the predictive maintenance device according to the second aspect, the disturbance removal unit obtains the disturbance-removed waveform by subtracting a direct current component corresponding to a 0-th component of the cepstrum from the logarithmic spectrum.

According to a ninth aspect of the present invention, in the predictive maintenance device according to the first aspect, the chi-square goodness-of-fit test processing unit performs gain correction of reducing a frequency on a low power side or a low amplitude side and increasing a frequency on a high power side or a high amplitude side in the histograms of the inspection product and the normal product, and the chi-square goodness-of-fit test processing unit calculates the chi-square goodness-of-fit test statistic by using the histogram of the inspection product after the gain correction and the histogram of the normal product after the gain correction. In addition, according to a tenth aspect of the present invention, in the predictive maintenance device according to the second aspect, the chi-square goodness-of-fit test processing unit performs gain correction of reducing a frequency on a low power side or a low amplitude side and increasing a frequency on a high power side or a high amplitude side in the histograms of the inspection product and the normal product, and the chi-square goodness-of-fit test processing unit calculates the chi-square goodness-of-fit test statistic by using the histogram of the inspection product after the gain correction and the histogram of the normal product after the gain correction.

With this configuration, the predictive maintenance device according to the ninth aspect and the tenth aspect of the present invention can amplify an effect of a peak appearing in the disturbance-removed waveform in a case where the target unit fails, suppress an effect of a change due to the noise, and detect the abnormality sign of the target unit with high accuracy.

According to an eleventh aspect of the present invention, there is provided a predictive maintenance method of detecting an abnormality sign of a target unit to be monitored forming a part of an apparatus, the predictive maintenance method including: a time waveform data acquisition step of acquiring time waveform data of a current or a voltage of the target unit during operation, which is measured by a measurement circuit; an FFT step of performing Fourier transform on the time waveform data to obtain a spectrum of the time waveform data; a disturbance removal step of obtaining a disturbance-removed waveform by removing an effect of a disturbance from any of the spectrum, a logarithmic spectrum of the spectrum, a cepstrum of the logarithmic spectrum, and a logarithmic cepstrum of the cepstrum; a histogram creation step of creating a histogram of power or an amplitude of the disturbance-removed waveform; a chi-square goodness-of-fit test processing step of calculating a chi-square goodness-of-fit test statistic between the histogram obtained from an inspection product that is the target unit having a possibility of an abnormality and the histogram obtained from a normal product that is the normal target unit; and an abnormality determination step of determining whether or not the target unit as the inspection product is abnormal based on a P value corresponding to the chi-square goodness-of-fit test statistic.

According to a twelfth aspect of the present invention, the predictive maintenance method according to the eleventh aspect, further includes: division step of calculating a plurality of peak frequencies or peak times of a plurality of quefrencies according to an operation state of the target unit in the disturbance-removed waveform, and dividing the disturbance-removed waveform with a plurality of frequency sections or a plurality of time sections each including each of the peak frequencies or each of the peak times, in which in the histogram creation step, the histogram of the disturbance-removed waveform is created for each of the frequency sections or the time sections.

According to a thirteenth aspect of the present invention, in the predictive maintenance method according to the eleventh aspect, in the disturbance removal step, the disturbance-removed waveform is obtained by dividing a value of power or an amplitude of the spectrum by an integral value related to a frequency of the spectrum.

According to a fourteenth aspect of the present invention, in the predictive maintenance method according to the eleventh aspect, in the disturbance removal step, the disturbance-removed waveform is obtained by dividing a value of power or an amplitude of the cepstrum by an integral value related to a time of the cepstrum.

According to a fifteenth aspect of the present invention, in the predictive maintenance method according to the eleventh aspect, in the disturbance removal step, the disturbance-removed waveform is obtained by subtracting a direct current component corresponding to a 0-th component of the cepstrum from the logarithmic spectrum.

According to a sixteenth aspect of the present invention, in the predictive maintenance method according to the eleventh aspect, in the chi-square goodness-of-fit test processing unit, gain correction of reducing a frequency on a low power side or a low amplitude side and increasing a frequency on a high power side or a high amplitude side in the histograms of the inspection product and the normal product is performed, and the chi-square goodness-of-fit test processing step, the chi-square goodness-of-fit test statistic is calculated by using the histogram of the inspection product after the gain correction and the histogram of the normal product after the gain correction.

### Advantage of the Invention

The present invention provides a predictive maintenance device and a predictive maintenance method capable of detecting an abnormality sign of a target unit to be monitored with high accuracy.

### BRIEF DESCRIPTION OF THE DRAWINGS

FIG. 1 is a diagram illustrating a configuration of a predictive maintenance device according to an embodiment of the present invention.

FIG. 2A is a diagram illustrating a configuration of a motor and a motor drive circuit, which are target units of the predictive maintenance device according to the embodiment of the present invention, and a configuration of a measurement circuit using a shunt resistor, and FIG. 2B is a diagram illustrating a configuration of a measurement circuit using a clamp meter or a current transformer.

FIG. 3A is a table illustrating an example of various parameters related to rotation of the motor and a drive roller, and FIG. 3B is a table illustrating an example of various parameters related to a bearing of the drive roller.

FIG. 4 is a diagram of a maintenance screen illustrating an example of a logarithmic power spectrum and a plurality of frequency sections.

FIG. 5 is a diagram of a maintenance screen illustrating an example of a logarithmic power cepstrum and a plurality of time sections.

FIG. 6 is a flowchart illustrating a class width calculation algorithm executed by the predictive maintenance device according to the embodiment of the present invention.

FIG. 7 is a graph illustrating an example of a disturbance-removed waveform.

FIG. 8 is a diagram illustrating a part of the graph in FIG. 7.

FIG. 9 is a diagram illustrating provisional histogram created by a histogram creation unit provided in the predictive maintenance device according to the embodiment of the present invention.

FIG. 10A is a diagram illustrating a situation in which a frequency of a disturbance-removed waveform of a normal product and a frequency of disturbance-removed waveform of an abnormal product are equal to each other in one category, and FIG. 10B is a diagram illustrating a situation in which the frequency of the disturbance-removed waveform of the normal product and the frequency of the disturbance-removed waveform of the abnormal product are different from each other in one category.

FIG. 11 is a graph illustrating a chi-square distribution.

FIG. 12 is a table illustrating an example of a gain probability density, an expected frequency and an observed frequency, a ratio of the expected frequency and a ratio of the observed frequency, the expected frequency and the observed frequency after correction, and a χ² value, for the disturbance-removed waveform of the normal product and a disturbance-removed waveform of an inspection product.

FIG. 13 is a diagram illustrating an example of a histogram of a normal product, which is not gain-corrected, a histogram of the normal product, which is gain-corrected, a histogram of an inspection product, which is not gain-corrected, and a histogram of the inspection product, which is gain-corrected.

FIG. 14A is a table illustrating a change in a χ² value calculated by a chi-square goodness-of-fit test processing unit provided in the predictive maintenance device according to the embodiment of the present invention, with an operating time, and FIG. 14B is a table illustrating a P(t) value which is a change in a P value corresponding to the χ² value, with the operating time.

FIG. 15A is a graph illustrating a change in the average P(t) value with the operating time illustrated in FIG. 14B, and FIG. 15B is a graph illustrating a change in an abnormality degree with the operating time illustrated in FIG. 14B.

FIG. 16 is a diagram illustrating a normal operation screen displayed by a display unit provided in the predictive maintenance device according to the embodiment of the present invention.

FIG. 17 is a diagram illustrating an abnormality sign display screen displayed by a display unit provided in the predictive maintenance device according to the embodiment of the present invention.

FIG. 18 is a diagram illustrating a repair screen displayed by the display unit provided in the predictive maintenance device according to the embodiment of the present invention.

FIG. 19 is a diagram illustrating a state monitoring screen displayed by the display unit provided in the predictive maintenance device according to the embodiment of the present invention.

FIG. 20 is a diagram illustrating a mode selection screen displayed by the display unit provided in the predictive maintenance device according to the embodiment of the present invention.

FIG. 21 is a diagram illustrating a data collection execution screen displayed by the display unit provided in the predictive maintenance device according to the embodiment of the present invention.

FIG. 22 is a diagram illustrating a data registration screen displayed by the display unit provided in the predictive maintenance device according to the embodiment of the present invention.

FIG. 23 is a flowchart describing a process in a normal data collection mode of a predictive maintenance method using the predictive maintenance device according to the embodiment of the present invention.

FIG. 24 is a flowchart illustrating details of the process in step S16 of the flowchart in FIG. 23.

FIG. 25 is a flowchart describing a process in an abnormality determination mode for a normal use of the predictive maintenance method using the predictive maintenance device according to the embodiment of the present invention.

FIG. 26 is a diagram (part 1) illustrating a parameter setting screen displayed by the display unit provided in the predictive maintenance device according to the embodiment of the present invention.

FIG. 27 is a diagram (part 2) illustrating the parameter setting screen displayed by the display unit provided in the predictive maintenance device according to the embodiment of the present invention.

### BEST MODE FOR CARRYING OUT THE INVENTION

Hereinafter, embodiments of a predictive maintenance device and a predictive maintenance method according to the present invention will be described with reference to the drawings.

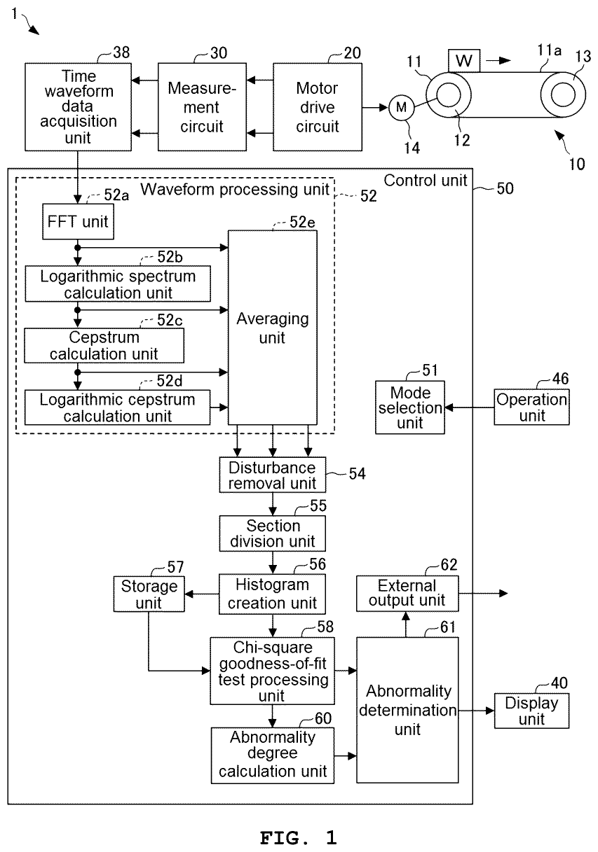

As illustrated in FIG. 1, a predictive maintenance device 1 according to the present embodiment detects an abnormality sign of a target unit to be monitored, and includes a measurement circuit 30, a time waveform data acquisition unit 38, and a control unit 50 including a display unit 40 and an operation unit 46.

The target unit is a component or a unit constituting a machine apparatus, and is, for example, a component constituting various article inspection apparatuses or sorters. More specifically, for example, the target unit is a motor and a drive roller mounted on a transport unit 10 provided in various article inspection apparatuses.

The transport unit 10 is, for example, a belt conveyor including a loop-shaped transport belt 11, a drive roller 12 and a driven roller 13 around which the loop-shaped transport belt 11 is wound, a motor 14 that drives the drive roller 12, and a motor drive circuit 20, and sequentially transports a transport article W placed on a transport surface 11a of the transport belt 11.

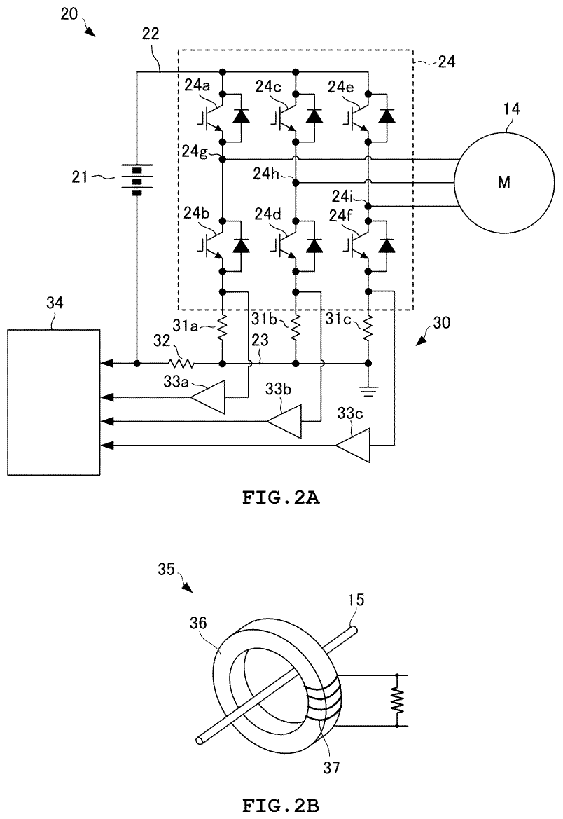

As illustrated in FIG. 2A, the motor 14 is driven by the motor drive circuit 20 that converts a direct current voltage from a direct current power supply 21 into a three-phase alternating current voltage. The direct current power supply 21 outputs the direct current voltage to an inverter circuit 24 via a pair of power supply lines 22 and 23. A shunt resistor 32 is provided on the negative power supply line 23.

The inverter circuit 24 has a three-phase bridge configuration in which a series circuit of switching elements 24a and 24b, a series circuit of switching elements 24c and 24d, and a series circuit of switching elements 24e and 24f are connected in parallel between the power supply lines 22 and 23.

A U-phase output terminal 24g, a V-phase output terminal 24h, and a W-phase output terminal 24i of the inverter circuit 24 are connected to a coil of each phase wound around a stator provided in the motor 14.

Hereinafter, as an example, a case where the motor 14 is a motor having 14 poles and 12 slots will be described. Here, the number of poles is the number of magnetic poles of a rotor provided in the motor 14, and the number of slots is the number of coils wound around the stator provided in the motor 14.

As a phase current flowing through each coil makes one round, the rotor is attracted to the coil side and rotates by a value (2/number of poles) obtained by dividing 2 by the number of poles. That is, since the phase current makes 7 laps while the motor of 14 poles and 12 slots makes one lap, a peak appears in a spectrum of the phase current at a frequency that is 7 times a frequency corresponding to a rotation speed [rpm] of the motor 14. Hereinafter, frequency obtained by multiplying the number of poles/2 by the frequency corresponding to the rotation speed [rpm] of the motor 14 is referred to as a “cogging frequency”.

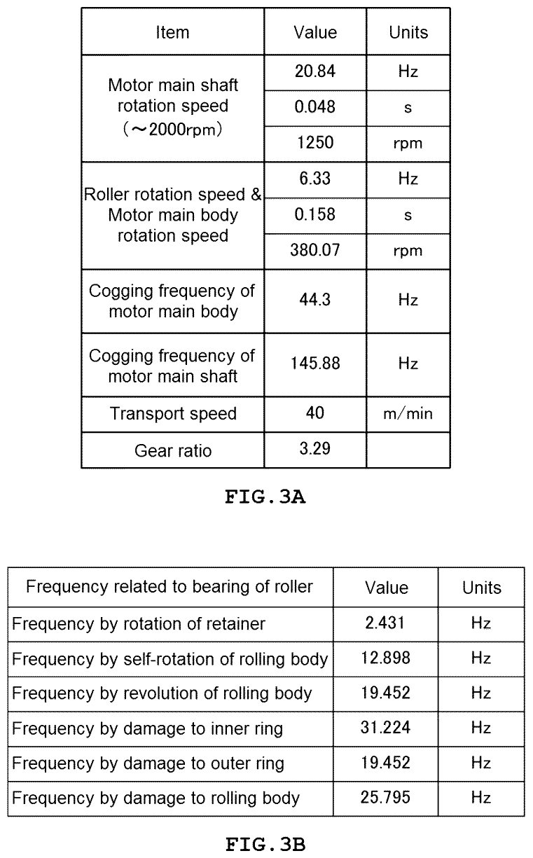

FIG. 3A is a table illustrating an example of various parameters related to rotation of the motor 14 and the drive roller 12. In a case where a main shaft rotation speed of the motor 14, which is the motor having 14 poles and 12 slots, is 1250 rpm, a rotation frequency of the main shaft of the motor 14 is 20.84 Hz, a rotation period of the main shaft of the motor 14 is 0.048 s, and a cogging frequency of the main shaft of the motor 14 is 145.88 Hz.

In addition, in a case where a gear ratio between the motor 14 and the drive roller 12 is 3.29, the rotation speed of the drive roller 12 (the rotation speed of the motor 14 body) is 380.07 rpm, the rotation frequency of the drive roller 12 is 6.33 Hz, and the rotation period of the drive roller is 0.158 s. The cogging frequency of the motor 14 main body in this case is 44.3 Hz. In addition, the transport speed of the transport unit 10 is 40 m/min.

FIG. 3B is a table illustrating an example of various parameters related to a bearing of the drive roller 12. As illustrated in FIG. 3B, a frequency by rotation of a retainer is 2.431 Hz, the frequency by self-rotation of a rolling body is 12.898 Hz, the frequency by revolution of the rolling body is 19.452 Hz, the frequency by a damage to an inner ring is 31.224 Hz, the frequency by the damage to an outer ring is 19.452 Hz, and the frequency by the damage to the rolling body is 25.795 Hz.

The measurement circuit 30 illustrated in FIG. 2A measures a current (hereinafter, also referred to as a “1-phase current”) flowing in one phase of three phases UVW of the motor 14 and a current or a voltage proportional to a sum (hereinafter, also referred to as a “total current”) of the magnitude of the current flowing in each phase of the motor 14. The measurement circuit 30 includes, for example, shunt resistors 31a to 31c for measuring a 1-phase current, a shunt resistor 32 for measuring a total current, analog amplifiers 33a to 33c, and a controller 34.

In a configuration for measuring the 1-phase current, a current transformer (CT) or a clamp meter may be used instead of the shunt resistors 31a to 31c. In a configuration for measuring the total current, a current transformer (CT) or a clamp meter may be used instead of the shunt resistor 32. For example, as illustrated in FIG. 2B, the 1-phase current or the total current can be measured by attaching a magnetic core 36 of a CT 35 to an electrical wire 15 of 1-phase current or the total current of the three phases of the motor 14 and measuring a voltage at both ends of a coil 37 wound around the magnetic core 36.

The 1-phase current and the total current of the measurement circuit 30 are either to be measured by measuring the current or to be measured by voltage conversion. Further, the measurement circuit 30 may include an acceleration sensor that measures vibration of the drive roller 12 or the motor 14, or a microphone that measures sound of the drive roller 12 or the motor 14.

The time waveform data acquisition unit 38 includes, for example, a low-pass filter for aliasing removal and an analog-digital converter (ADC), acquires time waveform data of a current, a voltage, vibration, sound, or the like measured by the measurement circuit 30 at a predetermined sampling frequency (for example, 4 kHz), and performs window function processing. In the following, a case where the time waveform data acquisition unit 38 acquires time waveform data of the 1-phase current or time waveform data of the total current measured by the measurement circuit 30 will be described as an example.

The control unit 50 includes a mode selection unit 51, a waveform processing unit 52, a disturbance removal unit 54, a section division unit 55, a histogram creation unit 56, a storage unit 57, a chi-square goodness-of-fit test processing unit 58, an abnormality degree calculation unit 60, an abnormality determination unit 61, and an external output unit 62.

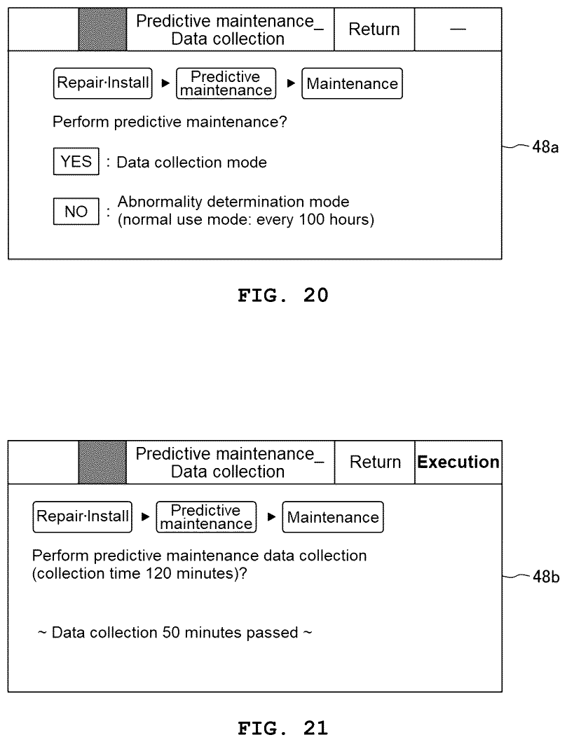

As illustrated in FIG. 20 to be described later, the mode selection unit 51 switches an operation mode of the predictive maintenance device 1 between a normal data collection mode and an abnormality determination mode for a normal use. For example, the mode selection unit 51 is configured to select the operation mode of the predictive maintenance device 1 in response to an operation input to the operation unit 46 by a user.

Here, the normal data collection mode is an operation mode in which a histogram of normal time waveform data (hereinafter, also referred to as “normal data”) obtained from a device (hereinafter, also referred to as “normal product”) of the same type as a target unit to be monitored and in a normal state is collected. It is desirable that the collection of the histogram of the normal data is performed, for example, before shipment of an article inspection apparatus including the target unit, during an idle operation before the start of the production, immediately after the replacement of the target unit, and the like.

The abnormality determination mode is an operation mode in which a histogram of time waveform data of an abnormality determination target obtained from the target unit (hereinafter, also referred to as an “inspection product”) having a possibility of an abnormality is compared with a histogram of normal data to detect an abnormality sign of the target unit and determine an abnormality of the target unit (that is, whether or not the inspection product is an abnormal product).

The waveform processing unit 52 includes an FFT unit 52a, a logarithmic spectrum calculation unit 52b, a cepstrum calculation unit 52c, a logarithmic cepstrum calculation unit 52d, and an averaging unit 52e.

The FFT unit 52a performs a fast Fourier transform (FFT) on the time waveform data acquired by the time waveform data acquisition unit 38 to obtain a spectrum of the time waveform data. Here, the spectrum is a general term for a power spectrum or an amplitude spectrum.

The logarithmic spectrum calculation unit 52b calculates a logarithmic spectrum with dB notation from the spectrum obtained by the FFT unit 52a. Here, the logarithmic spectrum is a general term for a logarithmic power spectrum or a logarithmic amplitude spectrum.

A waveform of the 1-phase current or the total current flowing through the motor 14 fluctuates due to the effect of the disturbance. The expected disturbance effect is, for example, an effect mainly caused by a change in a use environment inside and outside the device, such as contraction or expansion of the transport belt 11 or adhesion of dirt, a change in hardness of grease inside the drive system such as the drive roller 12 and the motor 14, and a change in temperature and humidity of a circuit such as the motor drive circuit 20.

The cepstrum calculation unit 52c calculates a cepstrum by performing inverse fast Fourier transform (IFFT) on the logarithmic spectrum with dB notation calculated by the logarithmic spectrum calculation unit 52b. Here, the cepstrum is a general term for a power cepstrum or an amplitude cepstrum.

The logarithmic cepstrum calculation unit 52d obtains a logarithmic cepstrum with dB notation from the cepstrum calculated by the cepstrum calculation unit 52c. Here, the logarithmic cepstrum is a general term for a logarithmic power cepstrum or a logarithmic amplitude cepstrum.

The FFT unit 52a, the logarithmic spectrum calculation unit t 52b, the cepstrum calculation unit 52c, and the logarithmic cepstrum calculation unit 52d calculate a plurality of spectra, a plurality of logarithmic spectra, a plurality of cepstra, and a plurality of logarithmic cepstra, respectively, by using a plurality of pieces of time waveform data acquired by the time waveform data acquisition unit 38.

The averaging unit 52e respectively averages the plurality of spectra, the plurality of logarithmic spectra, the plurality of cepstra, and the plurality of logarithmic cepstra calculated by the FFT unit 52a, the logarithmic spectrum calculation unit 52b, the cepstrum calculation unit 52c, and the logarithmic cepstrum calculation unit 52d.

The disturbance removal unit 54 obtains a disturbance-removed waveform by removing the effect of the disturbance from the spectrum, the cepstrum, the logarithmic spectrum, or the logarithmic cepstrum averaged by the averaging unit 52e. The disturbance removal unit 54 performs any process of “standardization removal” or “cepstrum removal” to be described below to calculate the disturbance-removed waveform.

### Standardization Removal

First, an example of a standardization removal process of the disturbance removal unit 54 will be described. For example, as indicated in the following Equation (1), the disturbance removal unit 54 calculates a standardized spectrum gₙₒᵣₘ(f) as a disturbance-removed waveform by dividing a value of power or an amplitude of a spectrum gₗᵢ(f) by an integral value with respect to a frequency f of the spectrum gₗᵢ(f) with magnification notation. fₘₐₓ in Equation (1) is a frequency of ½ of a sampling frequency in the time waveform data acquisition unit 38.

$${g}_{norm} ( f ) = \frac{{g}_{li} ( f )}{{\int }_{0}^{{f}_{max}} {g}_{li} ( f ) df} \qquad ( 1 )$$

Further, as indicated in Equation (2), the disturbance removal unit 54 may calculate a standardized logarithmic spectrum Gₙₒᵣₘ(f) obtained by logarithmically transforming Equation (1) as the disturbance-removed waveform.

$${G}_{norm} ( f ) = 10 {log}_{10} ( {g}_{norm} ( f ) ) = {G}_{dB} - 10 {log}_{10} ( {\int }_{0}^{{f}_{max}} {g}_{li} ( f ) df ) \qquad ( 2 )$$

$$Here , {G}_{dB} = 10 {log}_{10} {g}_{li} ( f )$$

That is, the standardization process represented by Equation (2) is a process of obtaining the disturbance-removed waveform by subtracting a logarithm of the integral value of the spectrum gₗᵢ(f) over 0 to fₘₐₓ [Hz] from a value at each frequency of the logarithmic spectrum G_{dB}.

Alternatively, the standardization process by the disturbance removal unit 54 may be a process of dividing a value of power or an amplitude of a cepstrum by an integral value over a time of the cepstrum in magnification notation to calculate the disturbance-removed waveform.

Alternatively, the standardization process by the disturbance removal unit 54 may be a process of obtaining the disturbance-removed waveform by subtracting the logarithm of the integral value over the entire time of the cepstrum from the value of the logarithmic cepstrum at each time.

The standardization process is equivalent to dividing the value of the waveform by an area of the entire waveform such that the energy (area) of the waveform of the spectrum or the cepstrum is constant.

### Cepstrum Removal

Next, an example of a cepstrum removal process of the disturbance removal unit 54 will be described. For example, the disturbance removal unit 54 subtracts a direct current component corresponding to a 0-th component of a cepstrum averaged by the averaging unit 52e from a logarithmic power spectrum averaged by the averaging unit 52e to obtain a disturbance-removed waveform from which the disturbance effect is removed.

Here, time waveform data gₙ(t) obtained in the n-th measurement by the time waveform data acquisition unit 38 is represented by Equation (3) in a case where a constant due to the disturbance effect that does not depend on time and frequency is X(n) and original time waveform data without the disturbance effect is f(t).

gₙ(t)=f(t)X(n) (3)

The time waveform data gₙ(t) is subjected to FFT by the FFT unit 52a and is transformed into a spectrum as indicated in the following Equation (4). Here, Gₙ(f) and F(f) are spectra of gn(t) and f(t), respectively.

[symbol]

[gₙ(t)]=Gₙ(f)=F(f)X(n) (4)

In a case where the logarithmic power spectrum is used as the logarithmic spectrum in the subsequent process, the spectrum Gₙ(f) is transformed into a logarithmic power spectrum L_{PS} with dB notation as indicated in Equation (5) by the logarithmic spectrum calculation unit 52b.

L_{PS}=20 log₁₀|Gₙ(f)|=20 log₁₀|F(f)|+20 log₁₀|X(n)| (5)

The logarithmic power spectrum L_{PS} with dB notation indicated in Equation (5) is subjected to IFFT by the cepstrum calculation unit 52c and transformed into a cepstrum as indicated in Equation (6a). Further, the cepstrum of Equation (6a) is a logarithmic power cepstrum as indicated in Equation (6b) by the logarithmic cepstrum calculation unit 52d.

[symbol]

[L_{PS}]= [symbol] [20 log₁₀|Gₙ(f)|]= [symbol] [20 log₁₀|F(f)|+20 log₁₀|X(n)|] (6a)

20 log₁₀| [symbol] [L_{PS}]|=20 log₁₀| [symbol] [20 log₁₀|Gₙ(f)|]| (6 b)

Here, in a case where q is set as a quefrency, the left side of Equation (6a) after averaging by the averaging unit 52e is denoted by Cg(q) and the right side in a case where q is not equal to 0 is denoted by c_{f}(q), Equation (6a) is represented as Equation (7).

$${c}_{g} ( q ) = \{ \begin{matrix}{c}_{g} ( 0 ) , & q = 0 \\ {c}_{f} ( q ) , & q \neq 0\end{matrix} \qquad ( 7 )$$

The cepstrum C_{g}(q) can be said to be obtained by performing FFT on the logarithmic power spectrum L_{PS} with dB notation represented by Equation (5) as if the spectrum is a time waveform. Therefore, the constant X(n) due to the disturbance effect is concentrated on the component of the cepstrum C_{g}(q) at the quefrency q=0. That is, C_{g}(0) is a direct current component including a component of a constant X(n), and corresponds to 10\hat{ }(C_{g}(0)/20) in the averaged logarithmic power spectrum L_{PS}. On the other hand, c_{f} (q≠0) is a component derived from the original time waveform data f(t) that does not include the component of the constant X(n).

That is, the disturbance removal unit 54 subtracts a direct current component 10\hat{ }(C_{g}(0)/20) corresponding to a 0-th (q=0) component of the cepstrum averaged by the averaging unit 52e from the logarithmic power spectrum averaged by the averaging unit 52e to obtain a disturbance-removed waveform.

Further, the disturbance removal unit 54 can also obtain a disturbance-removed waveform by removing the effect of the disturbance from the spectrum of the time waveform data output from the FFT unit 52a. In this case, the logarithmic spectrum calculation unit 52b calculates a logarithmic amplitude spectrum instead of the logarithmic power spectrum, the cepstrum calculation unit 52c calculates a cepstrum from the logarithmic amplitude spectrum, and the disturbance removal unit 54 subtracts a direct current component corresponding to the 0-th component of the averaged cepstrum from the averaged logarithmic amplitude spectrum.

As indicated in Equation (8), the disturbance-removed waveform Gₙₒᵣₘ(f) obtained by the cepstrum removal of the disturbance removal unit 54 is substantially equal to a waveform obtained by shifting the entire logarithmic power spectrum such that an average value of the waveform of the logarithmic power spectrum with dB notation is 0.

$${G}_{norm} ( f ) = {G}_{dB} - \frac{10}{{f}_{max}} {\int }_{0}^{{f}_{max}} {log}_{10} {g}_{li} ( f ) df \qquad ( 8 )$$

Alternatively, the disturbance removal unit 54 may obtain a disturbance-removed waveform by removing the effect of the disturbance from the averaged logarithmic cepstrum. In this case, the disturbance-removed waveform is obtained by shifting the averaged logarithmic cepstrum such that the average value of the waveform of the averaged logarithmic cepstrum is 0.

In Equations (2) and (8), assuming that the spectrum gₗᵢ(f) is represented by gₗᵢ(f)=Xₙhₗᵢ(f) using a constant Xₙ that does not depend on a frequency, Equations (2) and (8) are represented by Equations (9) and (10), respectively.

$$\begin{matrix}{G}_{norm} ( f ) = {G}_{dB} - 10 {log}_{10} ( {\int }_{0}^{{f}_{max}} {X}_{n} {h}_{li} ( f ) df ) \\ = {G}_{dB} - 10 {log}_{10} {X}_{n} ( {\int }_{0}^{{f}_{max}} {h}_{li} ( f ) df ) \\ = {G}_{dB} - 10 {log}_{10} ( {\int }_{0}^{{f}_{max}} {h}_{li} ( f ) df ) - 10 {log}_{10} {X}_{n}\end{matrix} \qquad ( 9 )$$

$$\begin{matrix}{G}_{norm} ( f ) = {G}_{dB} - \frac{10}{{f}_{max}} {\int }_{0}^{{f}_{max}} {log}_{10} {X}_{n} {h}_{li} ( f ) df \\ = {G}_{dB} - \frac{10}{{f}_{max}} {\int }_{0}^{{f}_{max}} \{ {log}_{10} {X}_{n} + {log}_{10} {h}_{li} ( f ) \} df \\ = {G}_{dB} - \frac{10}{{f}_{max}} {\int }_{0}^{{f}_{max}} {log}_{10} {h}_{li} ( f ) df - \frac{10}{{f}_{max}} \times {f}_{max} {log}_{10} {X}_{n} \\ = {G}_{dB} - \frac{10}{{f}_{max}} {\int }_{0}^{{f}_{max}} {log}_{10} {h}_{li} ( f ) df - 10 {log}_{10} {X}_{n}\end{matrix} \qquad ( 10 )$$

That is, as indicated in Equation (9) and Equation (10), both the standardization removal and the cepstrum removal are processes of shifting the waveform of the logarithmic spectrum in the up-down direction by 10 log₁₀Xₙ, a value that does not depend on the frequency, and an effect of a noise that does not depend on the frequency can be removed.

In addition, as can be seen from Equation (2) and Equation (8), the results of the standardization removal and the results of the cepstrum removal do not basically match. For example, in the standardization removal, power or an amplitude of a peak of the logarithmic spectrum is aligned, whereas in the cepstrum removal, a waveform shape excluding the peak portion of the logarithmic spectrum is generally aligned. Therefore, the shift amount changes in the standardization removal with respect to the change in the peak of the logarithmic spectrum, whereas the shift amount does not change much in the cepstrum removal.

The section division unit 55 calculates a plurality of peak frequencies according to an operation state of the target unit in the disturbance-removed waveform derived from the spectrum or the logarithmic spectrum, and divides the disturbance-removed waveform with a plurality of frequency sections each including each peak frequency. Alternatively, the section division unit 55 may calculate a plurality of quefrency peak times according to the operation state of the target unit in the disturbance-removed waveform derived from the cepstrum or the logarithmic cepstrum, and divide the cepstrum with a plurality of quefrency time sections each including each peak time. Here, the operation state of the target unit is represented by, for example, a parameter related to the rotation of the motor 14 and the drive roller 12 as illustrated in FIGS. 3A and 3B.

That is, a main peak of the disturbance-removed waveform appears at each constant interval determined by various parameters related to the rotation of the motor 14 and the drive roller 12 illustrated in FIGS. 3A and 3B. Therefore, the section division unit 55 sets a frequency section and a quefrency time section with a section width at which each of the main peaks can be captured. Hereinafter, the frequency section and the time section are also simply referred to as “section” s.

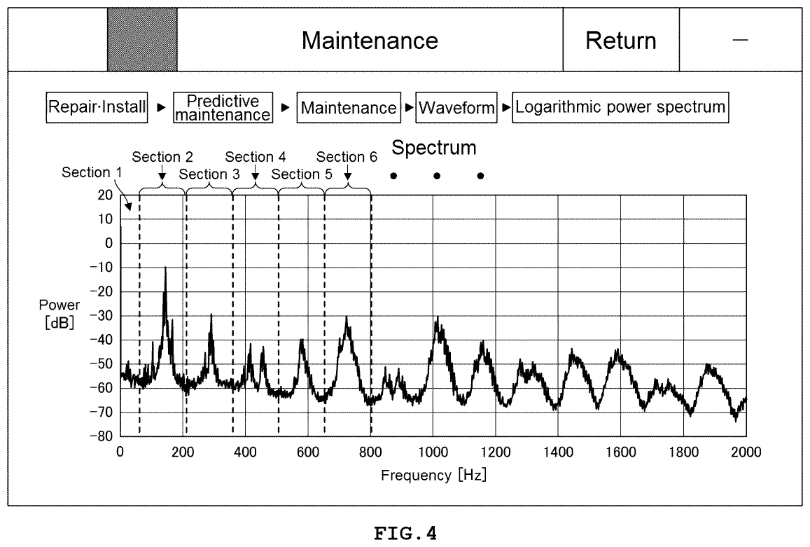

For example, the section division unit 55 calculates an integer multiple of a cogging frequency of the main shaft of the motor 14 as the plurality of peak frequencies of the disturbance-removed waveform, based on the number of poles and a main shaft rotation speed of the motor 14. As illustrated in a display example of a logarithmic power spectrum in FIG. 4, the section division unit 55 divides the disturbance-removed waveform with a plurality of frequency sections such that the integer multiple of the cogging frequency of the main shaft of the motor 14 is included in a center of the section, the cogging frequency of the main shaft of the motor 14 being used as a section width.

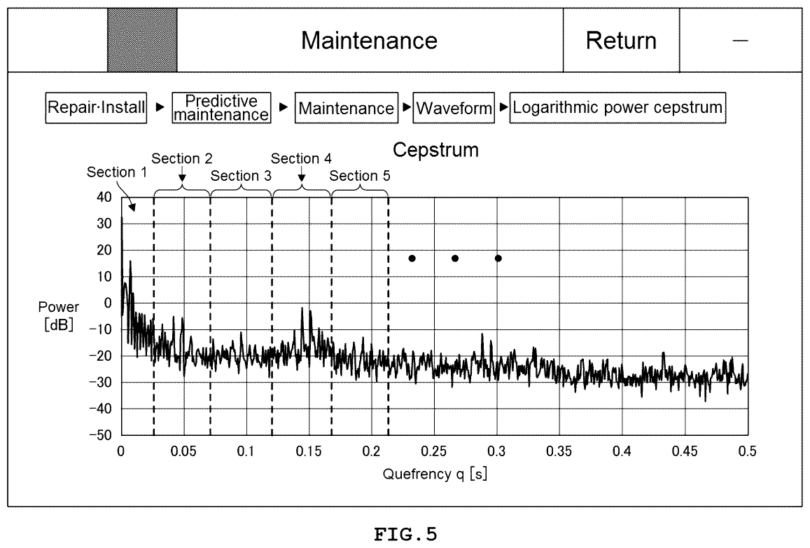

Alternatively, the section division unit 55 calculates, as the plurality of peak times of the disturbance-removed waveform, an integer multiple of a reciprocal of the main shaft rotation speed of the motor 14, that is, an integer multiple of the time required for one rotation of the motor 14, based on the main shaft rotation speed of the motor 14. In a display example of a logarithmic power cepstrum in FIG. 5, the section division unit 55 divides the cepstrum with a plurality of quefrency time sections such that the integer multiple of the reciprocal of the main shaft rotation speed of the motor 14 is included in a center of the section, the integer multiple of the reciprocal of the main shaft rotation speed of the motor 14 being used as the section width.

In the same manner, the section division unit 55 can also divide the disturbance-removed waveform based on the rotation speed of the motor 14 body, that is, a rotation speed of the drive roller 12. Alternatively, the section division unit 55 may divide the disturbance-removed waveform in various frequency sections or quefrency time sections input via the operation unit 46.

FIG. 4 is a diagram illustrating an example of the plurality of frequency sections ((section 1, section 2, section 3, section 4, section 5, section 6, . . . ) of a disturbance-removed waveform of a 1-phase current of the motor 14. A section width of each frequency section is equal to a cogging frequency (145.88 Hz) of the main shaft of the motor 14, except for the section 1 starting from a frequency of 0 Hz.

FIG. 5 is a diagram illustrating an example of the plurality of quefrency time sections (section 1, section 2, section 3, section 4, section 5, . . . ) of the disturbance-removed waveform of the 1-phase current of the motor 14. A section width of each time section is equal to the reciprocal (0.048 s) of the main shaft rotation speed of the motor 14, except for the section 1 starting from the time 0 s.

The storage unit 57 stores the disturbance-removed waveform divided by the section division unit 55 in a normal data collection mode by classifying the disturbance-removed waveform for each measurement condition. Here, the measurement condition is, for example, a sampling frequency in the time waveform data acquisition unit 38, a parameter related to the rotation of the motor 14 and the drive roller 12 as illustrated in FIGS. 3A and 3B, or the like.

The histogram creation unit 56 creates a histogram of the power of the amplitude of the disturbance-removed waveform for each frequency section or time section divided by the section division unit 55. The histogram created by the histogram creation unit 56 is stored in the storage unit 57.

In the normal data collection mode, the histogram creation unit 56 creates a provisional histogram with dB notation for each section from a plurality of disturbance-removed wave forms obtained from a normal product, and averages the provisional histograms for each section to complete a histogram for each section. In the same manner, the histogram creation unit 56 completes the histogram for each section from the plurality of disturbance-removed waveforms obtained from the inspection product in the abnormality determination mode.

Alternatively, the histogram creation unit 56 may create one disturbance-removed waveform by averaging the plurality of disturbance-removed waveforms with dB notation obtained the normal product in the normal data collection mode, and complete the histogram for each section from the disturbance-removed waveform. In the same manner, the histogram creation unit 56 may create one disturbance-removed waveform by averaging the plurality of disturbance-removed waveforms with dB notation obtained from the inspection product in the abnormality determination mode, and complete the histogram for each section from the disturbance-removed waveform.

In the histogram creation process by the histogram creation unit 56, an appropriate class width and the number of classes (the number of categories) in a case of dividing the power or the amplitude of the disturbance-removed waveform of the normal product with a plurality of classes (categories) are determined in accordance with constraints of an expected frequency and the degree of freedom in the following. Here, the minimum class width is, for example, 2 dB.

First, the constraint of the expected frequency will be described. In a case where the expected frequency is too small, the χ² (chi-square) distribution used in the predictive maintenance device 1 according to the present embodiment does not become an appropriate approximation of a sum of squares of a difference between the expected frequency and the observed frequency. Therefore, there are the following two constraints.
The expected frequency of all categories is 1 or more.
The category in which the expected frequency is less than 5 is less than 20% of all the categories.

Regarding the degree of freedom Q of the χ² distribution, in a case where the degree of freedom φ is 3 or more, the χ² distribution approaches a normal distribution, and reliability of the result of the χ² goodness-of-fit test is increased. Therefore, there are the following constraints.
The degree of freedom φ is 3 or more.

Since the histogram creation process by the histogram creation unit 56 is performed for each frequency section or each time section, the degree of freedom is determined for each of these sections.

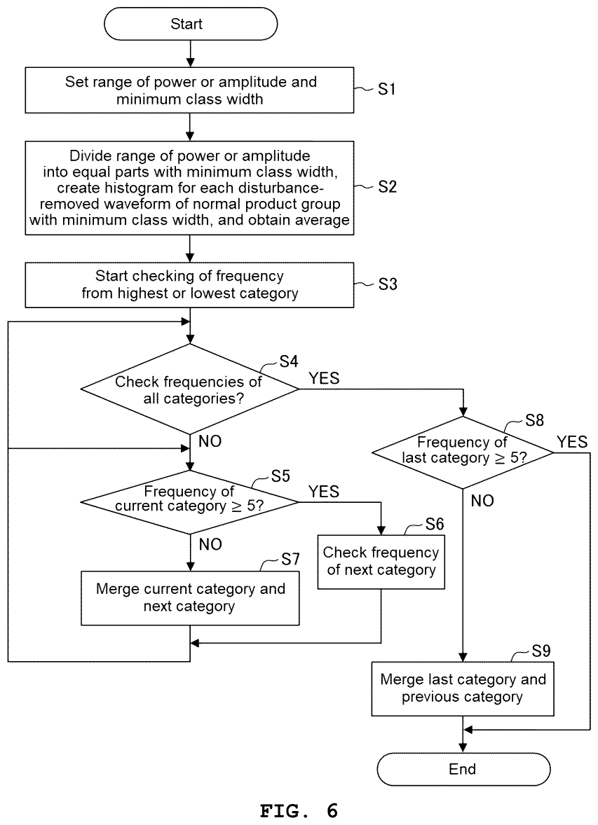

The class width is determined by the histogram creation unit 56 according to the following class width calculation algorithm using the disturbance-removed waveform of the normal product. FIG. 6 is a flowchart illustrating an example of a class width calculation algorithm by the histogram creation unit 56. Here, a process of setting frequencies of all categories to 5 or more will be described as an example.

First, the histogram creation unit 56 sets the maximum value and the minimum value of appropriate power or amplitude (dB) in consideration of a range of a disturbance-removed waveform of a normal product and an abnormal product, and the minimum class width (step S1).

Next, the histogram creation unit 56 divides the range of the power or the amplitude set in step S1 into equal parts with the minimum class width, creates a provisional histogram by creating a histogram for each disturbance-removed waveform of the normal product group with the minimum class width, and averages the provisional histograms (step S2).

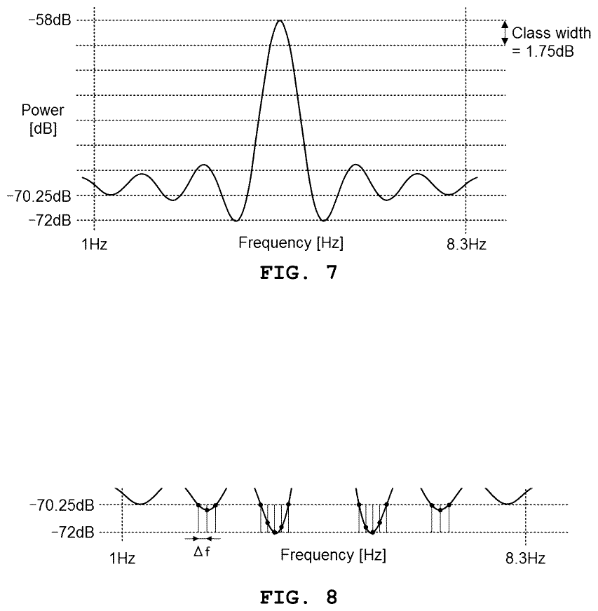

Hereinafter, the creation of the provisional histogram in step S2 will be described with reference to FIGS. 7 to 9.

FIG. 7 illustrates an example of a disturbance-removed waveform in which a frequency resolution Δf is 0.1 Hz in a frequency section of 1 to 8.3 Hz. In this example, the maximum value and the minimum value of the power are −58 dB and −72 dB, respectively, and the minimum class width is 1.75 dB. Therefore, the number of categories is 8.

FIG. 8 illustrates waveforms in a category of −72 to −70.25 dB of the disturbance-removed waveform in FIG. 7. In FIG. 8, the black circle indicates a point at which a frequency line arranged at an interval of the frequency resolution Δf and the disturbance-removed waveform intersect each other, and the number of these black circles represents the frequency (in this example, 16) in the category of −72 to −70.25 dB.

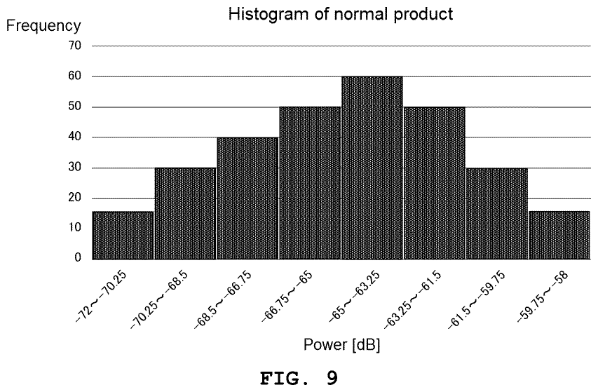

The histogram creation unit 56 respectively counts the frequencies of all categories including the category of −72 to −70.25 dB, and creates a provisional histogram as illustrated in FIG. 9.

Next, the histogram creation unit 56 starts checking the frequency in order from a category having the lowest power or amplitude (dB) or a category having the highest power or amplitude (dB) in the provisional histogram averaged in step S2 (step S3).

In a case where the histogram creation unit 56 checks the frequencies of all the categories (YES in step S4), a process in step S8, which will be described later, is executed.

In a case where there is a category of which the frequency is not checked by the histogram creation unit 56 (NO in step S4), the histogram creation unit 56 checks whether or not the frequency of the category being focused currently is 5 or more (step S5).

In a case where the frequency of the category being focused currently is 5 or more (YES in step S5), the histogram creation unit 56 checks a frequency of the next category (step S6).

In a case where the frequency of the category being focused currently is less than 5 (NO in step S5), the histogram creation unit 56 adds the frequency of the next category to the frequency of the category being focused currently and merges the two categories (step S7).

In step S8, the histogram creation unit 56 checks whether or not a frequency of the last category is 5 or more (step S8).

In a case where the frequency of the last category is 5 or more (YES in step S8), the process of the class width calculation algorithm ends.

In a case where the frequency of the last category is less than 5 (NO in step S8), the histogram creation unit 56 adds the frequency of the previous category to the frequency of the last category and merges the two categories (step S9). Then, the process of the class width calculation algorithm ends.

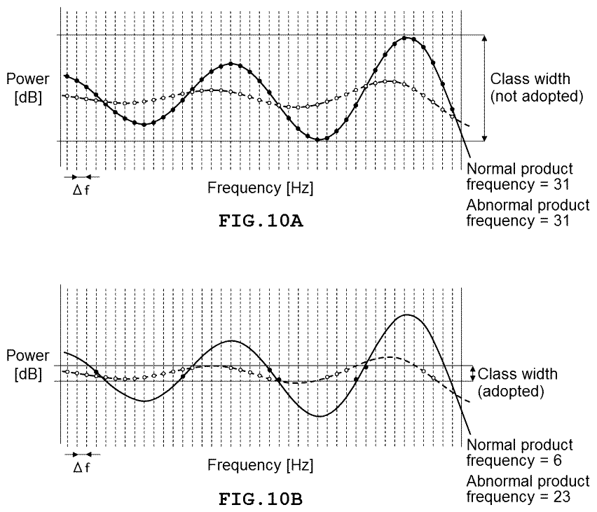

Hereinafter, an appropriate value of the minimum class width will be described with reference to FIGS. 10A and 10B.

As illustrated in FIG. 10A, in one category, in a case where a frequency of a disturbance-removed waveform of a normal product indicated by a black circle and a frequency of a disturbance-removed waveform of an abnormal product indicated by a white circle are equal, the normal product and the abnormal product cannot be distinguished from each other. This occurs, for example, in a case where a class width is equal to or larger than the maximum peak of the disturbance-removed waveform of the normal product (or the abnormal product), and the disturbance-removed waveform of the abnormal product (or the normal product) has only a peak smaller than the maximum peak.

Therefore, as illustrated in FIG. 10B, it is desirable that a sufficiently narrow minimum class width is set such that the frequency of the disturbance-removed waveform of the normal product indicated by the black circle and the frequency of the disturbance-removed waveform of the abnormal product indicated by the white circle are different from each other in one category. For example, in a case where the minimum class width is equal to or less than the minimum peak of the disturbance-removed waveform of the normal product (or the abnormal product) and the disturbance-removed waveform of the abnormal product (or the normal product) has only a peak larger than the minimum peak, the normal product and the abnormal product can be distinguished from each other by the difference in the frequency.

The chi-square goodness-of-fit test processing unit 58 applies a Pearson's χ² goodness-of-fit test to the histogram created by the histogram creation unit 56 using the disturbance-removed waveform of the inspection product and the histogram created by the histogram creation unit 56 using the disturbance-removed waveform of the normal product, and calculates a chi-square goodness-of-fit test statistic χ² (hereinafter, also simply referred to as a “χ² value”) between these histograms.

The Pearson's χ² goodness-of-fit test corresponds to a nonparametric test, and is to determine the degree of similarity between an observed frequency (actually obtained frequency) and an expected frequency (frequency calculated under null hypothesis).

Under the null hypothesis H₀ that the observed frequency Fᵢ fits the theoretical probability distribution, the χ² value is approximately obtained by Equation (11). The chi-square goodness-of-fit test processing unit 58 performs the goodness-of-fit test based on this. In Equation (11), k is the number of categories, pᵢ is a theoretical probability in the i-th category, and n is a total frequency of the observed frequencies F₁ to Fₖ in all the categories. The degree of freedom φ is k−1.

$${χ}^{2} = {\sum }_{i = 1}^{k} \frac{{( {F}_{i} - {np}_{i} )}^{2}}{{np}_{i}} ∼ {χ}^{2} ( k - 1 ) \qquad ( 11 )$$

In the present embodiment, the frequency of the disturbance-removed waveform of the normal product for each category is defined as an expected frequency npᵢ, and the frequency of the disturbance-removed waveform of the inspection product for each category is defined as an observed frequency Fᵢ. Therefore, the null hypothesis H₀ means that the inspection product is assumed to be a normal product and the expected frequency is the frequency of the normal product.

In the creation of the histogram of the disturbance-removed waveform by the histogram creation unit 56, a total frequency over all categories of the expected frequency of the normal product and a total frequency over all categories of the observed frequency of the inspection product need to be equal. In a case where the total frequencies do not match, for example, the total frequencies can be made to match by multiplying the expected frequency by a constant.

For example, in a case where the χ² value calculated by the chi-square goodness-of-fit test processing unit 58 is 28.4 and the degree of freedom φ is 13, in a case where a significance level α is 1% (=0.01), a rejection region is χ²>χ²_{0.01}=27.688. Since χ²=28.4 (>27.688) falls into the rejection region, the null hypothesis H₀ is rejected. In this case, the inspection product is determined to be an abnormal product by the abnormality determination unit 61 to be described later.

Alternatively, the chi-square goodness-of-fit test processing unit 58 may acquire a P value (%) corresponding to the χ² value based on the χ² value and the degree of freedom φ. The P value (%) of predictive maintenance represents a probability of a normal state, and the smaller the value is, the more the abnormal state deviates from the normal state.

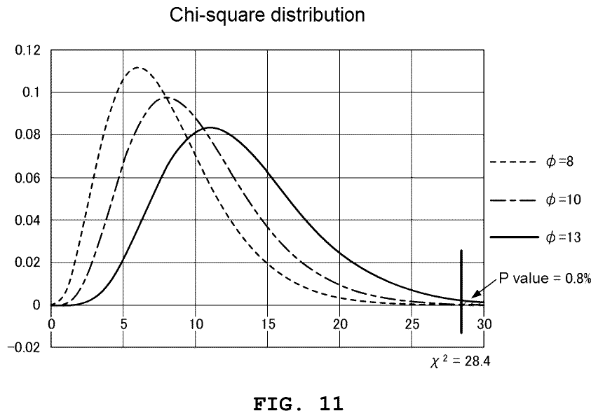

In a case where χ²=28.4 and φ=13, the P value is 0.008 (0.8%) given by the area of the region of 28.4 or more in the χ² distribution as illustrated in FIG. 11. In this case, in a case where the significance level α (that is, a threshold value of the P value) is set to 1%, since 0.8%<18, the abnormality determination unit 61 to be described later determines that the inspection product is an abnormal product.

Since the disturbance-removed waveform based on the spectrum obtained by the FFT unit 52a has many frequencies at low power (or low amplitude), in a case where the goodness-of-fit test is performed as it is, an effect of a change due to a noise appearing in the low power (or low amplitude) category may be dominant, and erroneous determination may occur in the abnormality determination unit 61 to be described later.

Therefore, the chi-square goodness-of-fit test processing unit 58 amplifies an effect of a peak appearing in the disturbance-removed waveform in a case where the target unit fails and suppresses an effect of a change due to the noise, and thus the expected frequency and the observed frequency can be corrected by a gain probability density αᵢ.

Hereinafter, the gain correction by the chi-square goodness-of-fit test processing unit 58 will be described. In order to perform the gain correction while maintaining a total frequency of each of an expected frequency and an observed frequency, the chi-square goodness-of-fit test processing unit 58 transforms a representative value of each category from dB notation to magnification notation, uses a ratio of each category as the gain probability density, and performs a process of multiplying the gain probability density by the expected frequency and the observed frequency.

Equation (12a) represents the ratio of each category after transforming the representative value of each category of the logarithmic power spectrum or the logarithmic power cepstrum from dB notation to magnification notation. Equation (12b) represents the ratio of each category after transforming the representative value of each category of the logarithmic amplitude spectrum or the logarithmic amplitude cepstrum from dB notation to magnification notation. The gain distribution represented by the gain probability density αᵢ is smaller on the low power (or low amplitude) side category and larger on the high power (or high amplitude) side category.

$${α}_{i} = \begin{matrix}gain probability density \\ ( gain distribution )\end{matrix} = \frac{{10}^{\frac{representative category value ( dB )}{20} \text{?}}}{{\sum }_{i = 1}^{K} {10}^{\frac{representative category value ( dB )}{10} \text{?}}} \qquad ( 12 a )$$

$${α}_{i} = \begin{matrix}gain probability density \\ ( gain distribution )\end{matrix} = \frac{{10}^{\frac{representative category value ( dB )}{20} \text{?}}}{{\sum }_{i = 1}^{K} {10}^{\frac{representative category value ( dB )}{10} \text{?}}} \qquad ( 12 b )$$

$$\text{?} \text{indicates text missing or illegible when filed}$$

Equation (13) indicates a χ² value obtained by multiplying the observed frequency Fᵢ of the inspection product and the expected frequency npᵢ of the normal product in Equation (11) by the gain probability density di.

$${χ}^{2} = {\sum }_{i = 1}^{k} \frac{{( {α}_{i} {F}_{i} - {α}_{i} n {p}_{i} )}^{2}}{{α}_{i} {np}_{i}} ∼ {χ}^{2} ( k - 1 ) \qquad ( 13 )$$

In Equation (14), a sum of all values over all the categories obtained by multiplying the ratio αᵢFᵢ of the observed frequency by the correction coefficient (ΣFᵢ/(ΣαᵢFᵢ)) is made to match the total frequency n over all the categories of the original observed frequency Fᵢ with respect to Equation (13). In the same manner, in Equation (14), a correction is performed for Equation (13) such that the sum of all the values over all the categories obtained by multiplying the ratio αᵢnpᵢ of the expected frequency by the correction coefficient (Σnpᵢ/(Σαᵢnpᵢ)) matches the total frequency over all the categories of the original expected frequency npᵢ. That is, Equation (14) is an equation for performing a calculation of multiplying the observed frequency Fᵢ and the expected frequency npᵢ by a discrete probability density function having an integral area of 1, respectively.

$${χ}^{2} = {\sum }_{i = 1}^{k} \frac{{( \frac{{α}_{i} {F}_{i} {\sum }_{i = 1}^{k} {F}_{i}}{{\sum }_{i = 1}^{k} {α}_{i} {F}_{i}} - \frac{{α}_{i} {np}_{i} {\sum }_{i = 1}^{k} {np}_{i}}{{\sum }_{i = 1}^{k} {α}_{i} {np}_{i}} )}^{2}}{\frac{{α}_{i} {np}_{i} {\sum }_{i = 1}^{k} {np}_{i}}{{\sum }_{i = 1}^{k} {α}_{i} {np}_{i}}} ∼ {χ}^{2} ( k - 1 ) \qquad ( 14 )$$

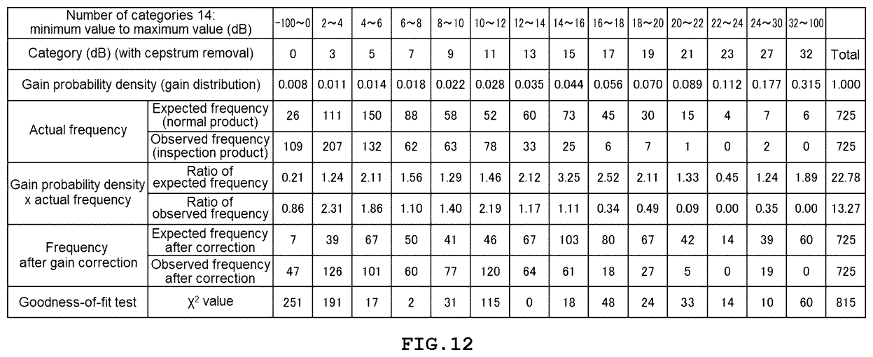

FIG. 12 is a table illustrating an example of the gain probability density, the expected frequency npᵢ and the observed frequency Fᵢ, the ratio αᵢnpᵢ of the expected frequency and the ratio αᵢFᵢ of the observed frequency, the expected frequency and the observed frequency after gain correction, and the χ² value for the disturbance-removed waveform of the normal product and the disturbance-removed waveform of the inspection product.

In the following, a representative category value of the lowest category among a plurality of categories is referred to as a “minimum category gain value”, and a representative category value of the highest category among the plurality of categories is referred to as a “maximum category gain value”. That is, in the example in FIG. 12, the representative category value of the category of −100 to 0 (dB) is the minimum category gain value, and the representative category value of the category of 32 to 100 (dB) is the maximum category gain value.

In the example in FIG. 12, except that the minimum category gain value is 0 which is the maximum value in a range of −100 to 0 (dB) and the maximum category gain value is 32 which is the minimum value in a range of 32 to 100 (dB), the representative category value is an average value of each category range.

In the example in FIG. 12, the χ² value after the gain correction is 815, and in a case where the threshold value of the P value is set to 1% (=0.01), χ²⁼⁸¹⁵ (>27.688) falls into the rejection region, and thus the null hypothesis H₀ is rejected. In this case, the inspection product is determined to be an abnormal product by the abnormality determination unit 61 to be described later.

As the minimum category gain value and the maximum category gain value in FIG. 12, for example, since the value affects the gain probability density of di, any one of the maximum value, the minimum value, or the average value of each category range can be selected.

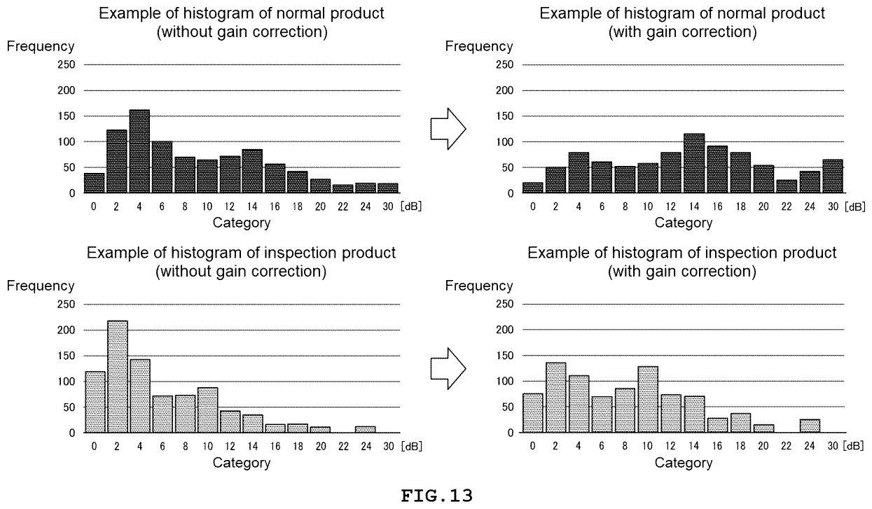

The upper part in FIG. 13 illustrates an example of a histogram of a normal product before gain correction and a histogram of the normal product after the gain correction. In addition, the lower part in FIG. 13 illustrates an example of a histogram of an inspection product before gain correction and a histogram of the inspection product after the gain correction.

As can be seen from FIG. 13, in the histogram before the gain correction, the distribution is biased toward the low power (or low amplitude) side category, but in the histogram after the gain correction, a balance between the low power (or low amplitude) side category and the high power (or high amplitude) side category is improved.

That is, the chi-square goodness-of-fit test processing unit 58 performs gain correction of reducing the frequency of the category on the low power side or the low amplitude side and increasing the frequency of the category on the high power side of the high amplitude side in the histograms of the inspection product and the normal product. In this case, the chi-square goodness-of-fit test processing unit 58 calculates the χ² value using the histogram of the inspection product after the gain correction and the histogram of the normal product after the gain correction.

The smaller the P value, the more abnormal the distribution of the histogram of the inspection product. Therefore, as illustrated in the following Equation (15), the abnormality degree calculation unit 60 calculates an abnormality degree a(t) by logarithmically transforming a reciprocal of the P value and multiplying the result by various constants (for example, 50). Here, t is an operating time of the inspection product, the abnormality degree a(t) represents a time change of the abnormality degree, and P(t) value represents a time change of the P value. A value of the abnormality degree a(t) defined in this manner becomes larger as the distribution of the histogram of the inspection product becomes more abnormal.

$$a ( t ) = 50 {log}_{10} ( \frac{1}{P ( t )} ) = - 50 {log}_{10} ( P ( t ) ) \qquad ( 15 )$$

In a case where there are N P values over a plurality of sections for each operating time, as indicated in Equation (16), the abnormality degree calculation unit 60 calculates the abnormality degree a(t) by using an average value of the P(t) values (hereinafter, also referred to as a “P(t) value average”).

$$a ( t ) = - 50 {log}_{10} ( \frac{\sum P ( t )}{N} ) \qquad ( 16 )$$

The abnormality determination unit 61 determines whether or not the inspection product is abnormal based on the P value acquired by the chi-square goodness-of-fit test processing unit 58.

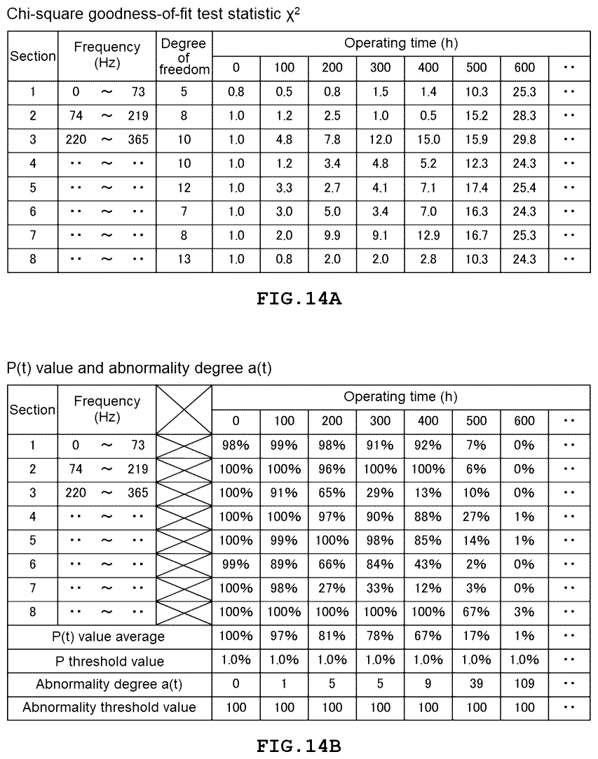

FIG. 14A illustrates a change in the χ² value calculated by the chi-square goodness-of-fit test processing unit 58 with an operating time for each frequency section (section 1, section 2, section 3, . . . ), which is divided by the section division unit 55. In addition, FIG. 14A also illustrates the degree of freedom for each frequency section.

FIG. 14B illustrates a P(t) value, which is a change associated with the operating time of the P value corresponding to the χ² value illustrated in FIG. 14A, for each frequency section (section 1, section 2, section 3, . . . ), which is divided by the section division unit 55. Further, FIG. 14B illustrates a P(t) value average, which is an average value of the P(t) values for each operating time, and an abnormality degree a(t) calculated by the abnormality degree calculation unit 60 using the P(t) value average.

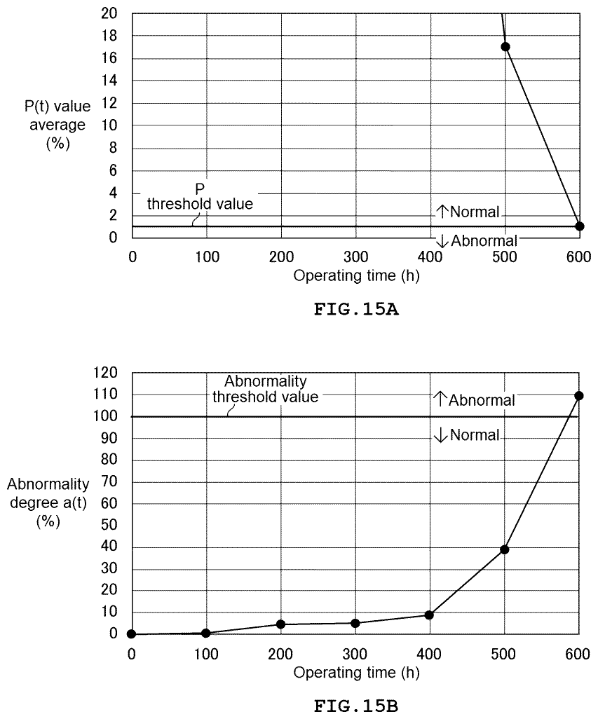

FIG. 15A is a graph illustrating a change in the P(t) value with the average operating time illustrated in FIG. 14B. The P threshold value is a determination threshold value of the P(t) value or the average of the P(t) values in the abnormality determination unit 61, and is, for example, a value of approximately 1% to 10%.

In a case where the P(t) value or the average of the P(t) values is equal to or greater than the P threshold value, the abnormality determination unit 61 determines that the inspection product is normal, and in a case where the P(t) value or the average of the P(t) values is less than the P threshold value, the abnormality determination unit 61 determines that the inspection product is abnormal.

FIG. 15B is a graph illustrating a change in the abnormality degree a(t) with the operating time illustrated in FIG. 14B. An abnormality threshold value is a determination threshold value of the abnormality degree a(t) in the abnormality determination unit 61, and is, for example, a value of approximately 50 to 100.

In a case where the abnormality degree a(t) is equal to or less than the abnormality threshold value, the abnormality determination unit 61 determines that the inspection product is normal, and in a case where the abnormality degree a(t) exceeds the abnormality threshold value, the abnormality determination unit 61 determines that the inspection product is abnormal.

The display unit 40 is configured to display the abnormality determination result in a case where the abnormality determination unit 61 determines that the inspection product is abnormal.

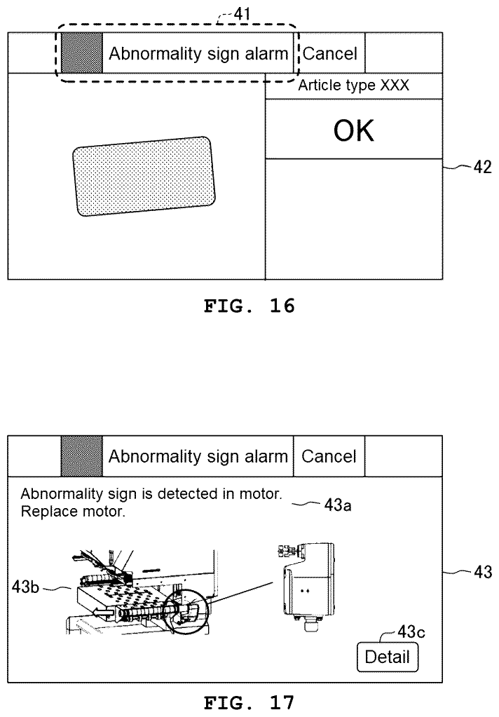

FIG. 16 is a normal operation screen 42 displayed by the display unit 40 in a case where inspection on the transport article W is performed by an article inspection apparatus including a target unit to be monitored. In a case where the abnormality determination unit 61 determines that the target unit is abnormal, the display unit 40 displays an abnormality sign alarm in an alarm display region 41 as an abnormality determination result. In this case, the external output unit 62 may externally output the abnormality sign alarm by serial communication or an external contact output.

In a case where the alarm display region 41 is pressed by an operation input to the operation unit 46 by a user, as illustrated in FIG. 17, a display screen of the display unit 40 transitions from the normal operation screen 42 to an abnormality sign display screen 43. On the abnormality sign display screen 43, a sentence 43a prompting replacement of the motor 14 which is the target unit, a picture 43b indicating a location of the target unit, and a detail button 43c are displayed.

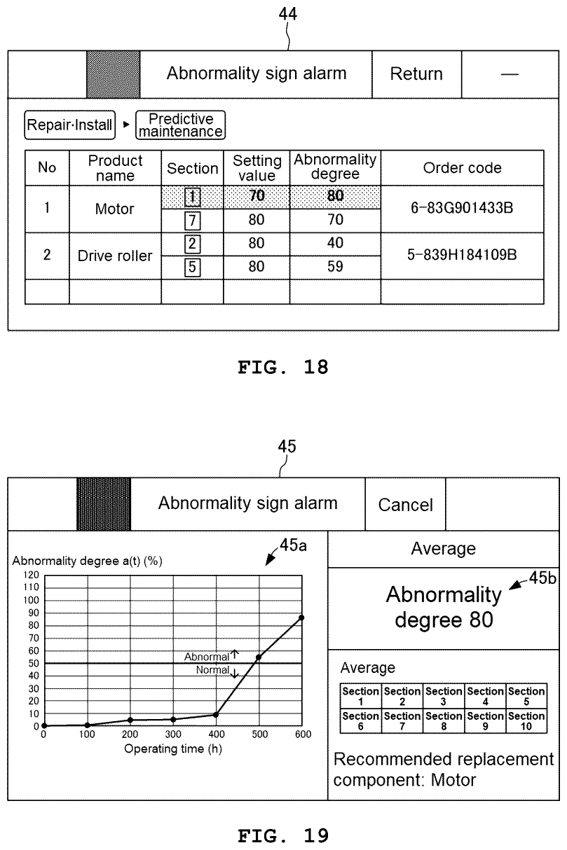

In a case where the detail button 43c is pressed by the operation input to the operation unit 46 by the user, as illustrated in FIG. 18, the display screen of the display unit 40 transitions from the abnormality sign display screen 43 to a repair screen 44. In the repair screen 44, a table illustrating a product name of the target unit, an abnormality degree in each section (frequency section or time section), and the like is displayed.

For example, in a case where a display location of the section 1 of a motor is selected on the repair screen 44 by the operation input to the operation unit 46 by the user, the display screen of the display unit 40 transitions from the repair screen 44 to a state monitoring screen 45 as illustrated in FIG. 19. For example, a graph 45a of the abnormality degree a(t) as illustrated in FIG. 15B and a numerical value 45b of the abnormality degree calculated by the abnormality degree calculation unit 60 are displayed on the state monitoring screen 45.

FIG. 20 is a mode selection screen 48a displayed by the display unit 40 to select an operation mode by the mode selection unit 51.

In a case where “YES” is selected on the mode selection screen 48a by the operation input to the operation unit 46 by the user, the operation mode is switched to the normal data collection mode, and as illustrated in FIG. 21, the display screen of the display unit 40 transitions from the mode selection screen 48a to the data collection execution screen 48b.

In a case where “execution” is selected on the data collection execution screen 48b by the operation input to the operation unit 46 by the user, collection of a disturbance-removed waveform of normal data is started, and an elapsed time from the start of the collection of the disturbance-removed waveform of the normal data is displayed.

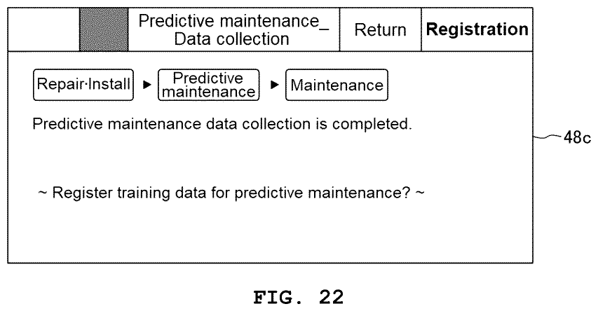

FIG. 22 is a data registration screen 48c displayed by the display unit 40 in a case where the collection of the disturbance-removed waveform of the normal data is completed in the normal data collection mode. In a case where “registration” is selected on the data registration screen 48c by the operation input to the operation unit 46 by the user, the disturbance-removed waveform of the collected normal data is stored in the storage unit 57.

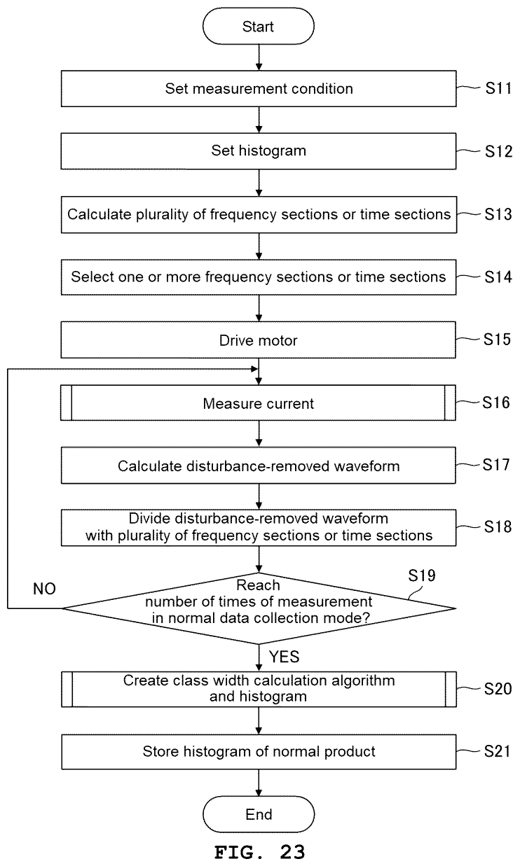

Hereinafter, an example of a process of a predictive maintenance method using the predictive maintenance device 1 will be described with reference to flowcharts in FIGS. 23 to 25. Description overlapping with the description of the configuration of the predictive maintenance device described above will be omitted as appropriate.

The flowchart in FIG. 23 illustrates a process in a case where the mode selection unit 51 selects the normal data collection mode by selecting “YES” in the mode selection screen 48a illustrated in FIG. 20 by the operation input to the operation unit 46 by the user.

First, various measurement conditions such as a sampling frequency in the time waveform data acquisition unit 38, a rotation speed and the number of poles of the motor 14, the degree of transport of the transport unit 10, and the number of times of collection (several hundred points) are set by an operation input to the operation unit 46 by a user (step S11).

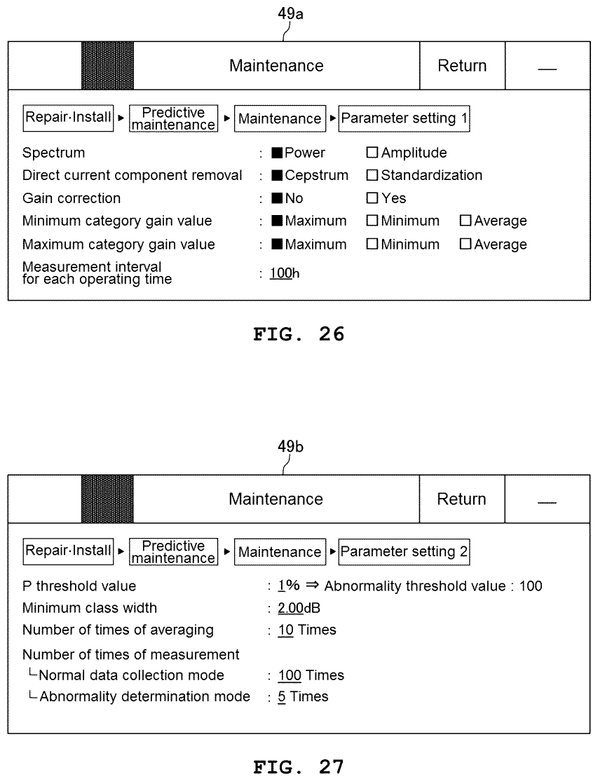

Next, the setting related to a histogram is performed on the parameter setting screens 49a and 49b illustrated in FIGS. 26 and 27 by the operation input to the operation unit 46 by the user (step S12).

As illustrated in FIGS. 26 and 27, the parameter setting screens 49a and 49b are screens for setting “spectrum”, “direct current component removal”, “gain correction”, “minimum category gain value”, “maximum category gain value”, “measurement interval for each operating time”, “P threshold value”, “minimum class width”, “number of times of averaging”, “number of times of measurement normal data collection mode”, and “number of times of measurement abnormality determination mode”, and are displayed on the display unit 40.

The “spectrum” is an item for selecting a type of a spectrum acquired by the FFT unit 52a. “Power” indicates a power spectrum, and “amplitude” indicates an amplitude spectrum. In the example in FIG. 26, the power spectrum is selected.

The “direct current component removal” is an item for selecting a method of removing a disturbance by the disturbance removal unit 54. “Cepstrum” indicates a cepstrum removal process, and “standardization” indicates a standardization removal process. In the example in FIG. 26, the cepstrum removal process is selected.

The “gain correction” is an item for selecting whether or not gain correction by the chi-square goodness-of-fit test processing unit 58 is performed. In the example in FIG. 26, a setting for not performing the gain correction is selected.

The “minimum category gain value” and the “maximum category gain value” are items for selecting the category minimum value and the category maximum value in a case of performing the gain correction. “Maximum” indicates the maximum value of each category range, “minimum” indicates the minimum value of each category range, and “average” indicates an average value of each category range. In the example in FIG. 26, the maximum value of each category range is selected. In the example in FIG. 12, the minimum category gain value has a maximum value of 0, a minimum value of −100, and an average of −50, and the maximum category gain value is a maximum value of 100, a minimum value of 32, and an average of 66.

Representative category values of categories other than the lowest and highest categories among a plurality of categories are automatically set to an average value of each category range.

The “measurement interval for each operating time” is an item for setting a time interval at which time waveform data of an inspection product is measured by the measurement circuit 30 in an operating time of the inspection product. In the example in FIG. 26, 100 hours are set.

The “P threshold value” is an item for setting a P threshold value in the abnormality determination unit 61. In the example in FIG. 27, 18 is set as the P threshold value, and an abnormality threshold value corresponding to the 1% P threshold value is 100.

The “minimum class width” is an item for setting the minimum class width of the histogram created by the histogram creation unit 56. In the example in FIG. 27, 2.00 dB is set.

The “number of times of averaging” is an item for setting the number of times M of averaging, which is the number of times of execution of a generation process of a spectrum, a logarithmic spectrum, a cepstrum, and a logarithmic cepstrum in the waveform processing unit 52. In the example in FIG. 27, 10 times are set.

The “number of times of measurement normal data collection mode” is an item for setting the number of times of collection of a disturbance-removed waveform of a normal product in the normal data collection mode as the number of times of measurement. In the example in FIG. 27, 100 times is set.

The “number of times of measurement abnormality determination mode” is an item for setting the number of times of collection of a disturbance-removed waveform of an inspection product in the abnormality determination mode as the number of times of measurement. In the example in FIG. 27, five times are set.

Next, the section division unit 55 calculates a section width and a center frequency (peak frequency) of a plurality of frequency sections or a section width and a center time (peak time) of a plurality of quefrency time sections, based on the measurement condition set in step S11 (step S13).

Next, one or more desired frequency sections or quefrency time sections are selected from the plurality of frequency sections or quefrency time sections calculated by the section division unit 55 by the operation input to the operation unit 46 (step S14).

Next, in a case where an operation input for providing an instruction to start the measurement is performed on the operation unit 46, the transport unit 10 starts driving the motor 14 (step S15). The measurement is performed in a state in which the transport unit 10, which is a transport belt conveyor, is operated in an idle state. A time of the start of the measurement is any of various operations by the user, regular measurement, or immediately after the start of operation.

Next, the waveform processing unit 52 generates a spectrum, a logarithmic spectrum, a cepstrum, and a logarithmic cepstrum by using time waveform data of a 1-phase current or time waveform data of the total current measured by the measurement circuit 30 (step S16).

Next, the disturbance removal unit 54 obtains a disturbance-removed waveform by removing the effect of the disturbance from the spectrum, the logarithmic spectrum, the cepstrum, or the logarithmic cepstrum calculated in step S16 (disturbance removal step S17).

Next, the section division unit 55 divides the disturbance-removed waveform obtained by the disturbance removal unit 54 with a plurality of frequency sections or time sections (step S18).

Next, in a case where the number of times of measurement reaches the number of times of measurement of the normal data collection mode set by the parameter setting screen 49b (YES in step S19), a process in step S20 is executed. On the other hand, in a case where the number of times of measurement has not reached the number of times of measurement in the normal data collection mode set by the parameter setting screen 49b (NO in step S19), the process in step S16 and subsequent steps is executed again.

In step S20, the histogram creation unit 56 creates a histogram of the power or the amplitude of the disturbance-removed waveform of the normal product for each frequency section or each time section divided by the section division unit 55 according to the class width calculation algorithm illustrated in FIG. 6 (histogram creation step S20).

Next, the histogram creation unit 56 stores the histogram created in step S20 in the storage unit 57 (step S21).

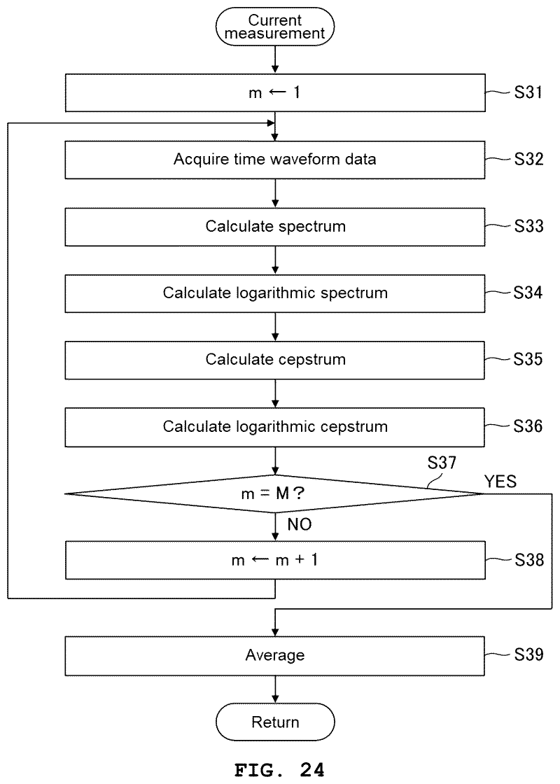

As illustrated in FIG. 24, the process in step S16 includes processes in steps S31 to S39.

First, the control unit 50 sets an initial value of the number of times m of execution of the process in steps S32 to S36 to 1 (step S31).

Next, the time waveform data acquisition unit 38 acquires the time waveform data of the 1-phase current or the time waveform data of the total current measured by the measurement circuit 30 (time waveform data acquisition step S32).

Next, the FFT unit 52a performs FFT on the time waveform data acquired by the time waveform data acquisition unit 38 to obtain a spectrum of the time waveform data (FFT step S33).

Next, the logarithmic spectrum calculation unit 52b calculates a logarithmic spectrum with dB notation from the spectrum obtained by the FFT unit 52a (logarithmic spectrum calculation step S34).

Next, the cepstrum calculation unit 52c obtains a cepstrum from the logarithmic power spectrum calculated by the logarithmic spectrum calculation unit 52b (cepstrum calculation step S35).

Next, the logarithmic cepstrum calculation unit 52d obtains a logarithmic cepstrum with dB notation from the cepstrum calculated by the cepstrum calculation unit 52c (step S36).

In a case where the number of times m of execution has not reached the number of times M of averaging set by the parameter setting screen 49b (NO in step S37), a process in step S38 is executed. On the other hand, in a case where the number of times m of execution reaches the number of times M of averaging set by the parameter setting screen 49b (YES in step S37), a process in step S39 is executed.

In step S38, the control unit 50 adds 1 to the current number of times m of execution (step S38).

Then, the processes after step S32 are executed again.

In step S39, the averaging unit 52e averages the M spectra, the M logarithmic spectra, the M cepstra, and the M logarithmic cepstra calculated by the FFT unit 52a, the logarithmic spectrum calculation unit 52b, the cepstrum calculation unit 52c, and the logarithmic cepstrum calculation unit 52d, respectively (step S39).

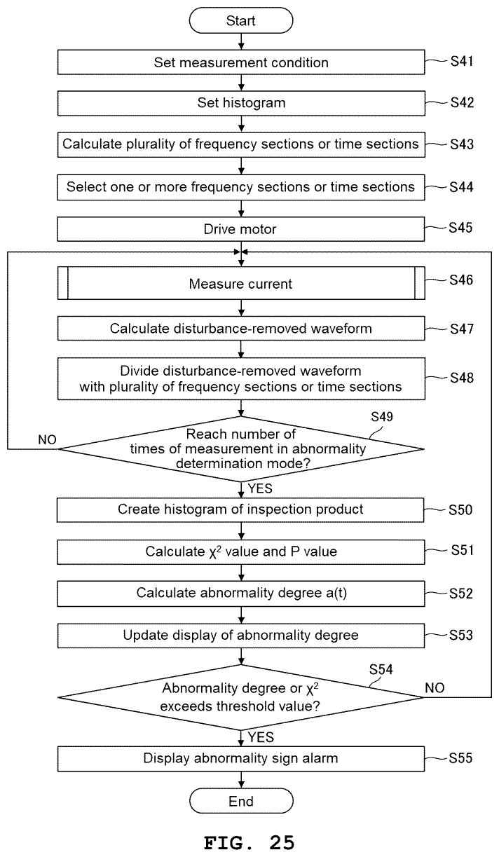

The flowchart in FIG. 25 illustrates a process in a case where the mode selection unit 51 selects an abnormality determination mode for a normal use by selecting “NO” by the operation input to the operation unit 46 by the user in the mode selection screen 48a illustrated in FIG. 20.

First, various measurement conditions such as a sampling frequency in the time waveform data acquisition unit 38, a rotation speed and the number of poles of the motor 14, the degree of transport of the transport unit 10, and the number of times of determination process (several points to several tens of points) are set by an operation input to the operation unit 46 by a user (step S41).

Next, a setting related to the histogram is performed on the parameter setting screens 49a and 49b illustrated in FIGS. 26 and 27 by the operation input to the operation unit 46 by the user (step S42).

Next, the section division unit 55 calculates a section width and a center frequency (peak frequency) of the plurality of frequency sections or a section width and a center time (peak time) of the plurality of quefrency time sections, based on the measurement condition set in step S41 (step S43).

Next, one or more desired frequency sections or time sections of the quefrency are selected from the plurality of frequency sections or quefrency time sections calculated by the section division unit 55 by the operation input to the operation unit 46 (step S44).

Next, in a case where an operation input for providing an instruction to start the measurement is performed on the operation unit 46, the transport unit 10 starts driving the motor 14 (step S45). The measurement is performed in a state in which the transport unit 10, which is a transport belt conveyor, is operated in an idle state. A time of the start of the measurement is any of various operations by the user, regular measurement, or immediately after the start of operation.

Next, the waveform processing unit 52 generates a spectrum, a logarithmic spectrum, a cepstrum, and a logarithmic cepstrum by using time waveform data of a 1-phase current or time waveform data of the total current measured by the measurement circuit 30 (step S46). The details of the process in step S46 are the same as the details of the process in step S16, and thus description thereof will be omitted.

Next, the disturbance removal unit 54 obtains a disturbance-removed waveform by removing the effect of the disturbance from the spectrum, the logarithmic spectrum, the cepstrum, or the logarithmic cepstrum calculated in step S46 (disturbance removal step S47).

Next, the section division unit 55 divides the disturbance-removed waveform obtained by the disturbance removal unit 54 with a plurality of frequency sections or time sections (step S48).

Next, in a case where the number of times of measurement reaches the number of times of measurement in the abnormality determination mode set by the parameter setting screen 49b (YES in step S49), a process in step S50 is executed. On the other hand, in a case where the number of times of measurement in the abnormality determination mode set by the parameter setting screen 49b has not been reached (NO in step S49), the process in step S46 and subsequent steps is executed again.

In step S50, the histogram creation unit 56 creates a histogram of the power or the amplitude of the disturbance-removed waveform of the inspection product for each frequency section or each time section divided by the section division unit 55 (histogram creation step S50).

Next, the chi-square goodness-of-fit test processing unit 58 calculates a χ² value by using the histogram created by the histogram creation unit 56 using the disturbance-removed waveform of the inspection product and the histogram created by the histogram creation unit 56 using the disturbance-removed waveform of the normal product (chi-square goodness-of-fit test processing step S51). Further, in step S51, the chi-square goodness-of-fit test processing unit 58 obtains a P value corresponding to the χ² value.

Next, the abnormality degree calculation unit 60 calculates the abnormality degree a(t) based on the P value obtained by the chi-square goodness-of-fit test processing unit 58 (step S52).

Next, the display unit 40 displays a graph of the abnormality degree a(t) as illustrated in FIG. 15B. Further, the display unit 40 displays the latest abnormality degree calculated by the abnormality degree calculation unit 60 in step S52 (step S53).

Next, in a case where the abnormality determination unit 61 determines that the abnormality degree a(t) exceeds an abnormality threshold value by designated number of times (YES in abnormality determination step S54), a process in step S55 is executed. On the other hand, in a case where the abnormality determination unit 61 determines that the abnormality degree a(t) does not exceed the abnormality threshold value (NO in abnormality determination step S54), the process in step S46 and subsequent steps is executed again at the next measurement.

In the abnormality determination step S54, instead of the abnormality degree a(t), it may be determined whether or not the χ² value exceeds a χ² threshold value corresponding to the P threshold value.

In step S55, the display unit 40 displays an abnormality sign alarm in the alarm display region 41 (display step S55).

As described above, the predictive maintenance device 1 according to the present embodiment determines whether or not the inspection product is abnormal based on the chi-square goodness-of-fit test statistic χ² between the histogram obtained from the disturbance-removed waveform of the inspection product, which is the target unit having a possibility of an abnormality, and the histogram obtained from the disturbance-removed waveform of the normal product, which is the normal target unit.

As a result, the predictive maintenance device 1 according to the present embodiment can clearly capture a change in a shape of the disturbance-removed waveform of the inspection product, and thus can detect an abnormality sign of the target unit with high accuracy. Therefore, with the predictive maintenance device 1 according to the present embodiment, it is possible to replace the target unit with a new product at an appropriate time before the target unit fails, and it is possible to significantly reduce a downtime of an article inspection apparatus including the target unit.

Further, since the predictive maintenance device 1 according to the present embodiment can mainly remove the disturbance effect caused by the change in the use environment inside and outside the target unit, the predictive maintenance can be performed immediately after the target unit is started to be operated.

In addition, the predictive maintenance device 1 according to the present embodiment calculates a plurality of peak frequencies or a plurality of quefrency peak times according to the operation state of the target unit in the disturbance-removed waveform, and creates a histogram of the disturbance-removed waveform for each frequency section or each time section including each peak frequency or each peak time.

As a result, the predictive maintenance device 1 according to the present embodiment can detect a small change in the disturbance-removed waveform by reducing the number of pieces of data to be processed in a case of creating the histogram of the disturbance-removed waveform.

In addition, the predictive maintenance device according to the present embodiment performs gain correction of reducing the frequency on the low power side or the low amplitude side and increasing the frequency on the high power side or the high amplitude side in the histograms of the inspection product and the normal product.

As a result, the predictive maintenance device 1 according to the present embodiment can amplify the effect of the peak appearing in the disturbance-removed waveform in a case where the target unit fails, suppress the effect of the change due to the noise, and detect the abnormality sign of the target unit with high accuracy.

### DESCRIPTION OF REFERENCE NUMERALS AND SIGNS

1: predictive maintenance device
10: transport unit (conveyor)
11: transport belt
11a: transport surface
12: drive roller (target unit to be monitored)
13: driven roller
14: motor (target unit to be monitored)
15: electrical wire
20: motor drive circuit
21: direct current power supply
22, 23: power supply line
24: inverter circuit
24a to 24f: switching element
24g: U-phase output terminal
24h: V-phase output terminal
24i: W-phase output terminal
30: measurement circuit
31a to 31c, 32: shunt resistor
33a to 33c: analog amplifier
34: controller
35: current transformer (CT)
36: magnetic core
37: coil
38: time waveform data acquisition unit
40: display unit
46: operation unit
50: control unit
51: mode selection unit
52: waveform processing unit
52a: FFT unit
52b: logarithmic spectrum calculation unit
52c: cepstrum calculation unit
52d: logarithmic cepstrum calculation unit
52e: averaging unit
54: disturbance removal unit
55: section division unit
56: histogram creation unit
57: storage unit
58: chi-square goodness-of-fit test processing unit
60: abnormality degree calculation unit
61: abnormality determination unit
62: external output unit
W: transport article

What is claimed is:

1. A predictive maintenance device that detects an abnormality sign of a target unit to be monitored forming a part of an apparatus, the predictive maintenance device comprising:
a measurement circuit that measures a current or a voltage of the target unit during operation;
a time waveform data acquisition unit that acquires time waveform data of the current or the voltage measured by the measurement circuit;
an FFT unit that performs Fourier transform on the time waveform data to obtain a spectrum of the time waveform data;
a disturbance removal unit that obtains a disturbance-removed waveform by removing an effect of a disturbance from any of the spectrum, a logarithmic spectrum of the spectrum, a cepstrum of the logarithmic spectrum, and a logarithmic cepstrum of the cepstrum;
a histogram creation unit that creates a histogram of power or an amplitude of the disturbance-removed waveform;
a chi-square goodness-of-fit test processing unit that calculates a chi-square goodness-of-fit test statistic between the histogram obtained from an inspection product that is the target unit having a possibility of an abnormality and the histogram obtained from a normal product that is the normal target unit; and
an abnormality determination unit that determines whether or not the target unit as the inspection product is abnormal based on a P value corresponding to the chi-square goodness-of-fit test statistic.

2. The predictive maintenance device according to claim 1, further comprising:
a section division unit that calculates a plurality of peak frequencies or peak times of a plurality of quefrencies according to an operation state of the target unit in the disturbance-removed waveform, and divides the disturbance-removed waveform with a plurality of frequency sections or a plurality of time sections each including each of the peak frequencies or each of the peak times,
wherein the histogram creation unit creates the histogram of the disturbance-removed waveform for each of the frequency sections or the time sections.

3. The predictive maintenance device according to claim 1,
wherein the disturbance removal unit obtains the disturbance-removed waveform by dividing a value of power or an amplitude of the spectrum by an integral value related to a frequency of the spectrum.

4. The predictive maintenance device according to claim 2,
wherein the disturbance removal unit obtains the disturbance-removed waveform by dividing a value of power or an amplitude of the spectrum by an integral value related to a frequency of the spectrum.

5. The predictive maintenance device according to claim 1,
wherein the disturbance removal unit obtains the disturbance-removed waveform by dividing a value of power or an amplitude of the cepstrum by an integral value related to a time of the cepstrum.

6. The predictive maintenance device according to claim 2,
wherein the disturbance removal unit obtains the disturbance-removed waveform by dividing a value of power or an amplitude of the cepstrum by an integral value related to a time of the cepstrum.

7. The predictive maintenance device according to claim 1,
wherein the disturbance removal unit obtains the disturbance-removed waveform by subtracting a direct current component corresponding to a 0-th component of the cepstrum from the logarithmic spectrum.

8. The predictive maintenance device according to claim 2,
wherein the disturbance removal unit obtains the disturbance-removed waveform by subtracting a direct current component corresponding to a 0-th component of the cepstrum from the logarithmic spectrum.

9. The predictive maintenance device according to claim 1,
wherein the chi-square goodness-of-fit test processing unit performs gain correction of reducing a frequency on a low power side or a low amplitude side and increasing a frequency on a high power side or a high amplitude side in the histograms of the inspection product and the normal product, and
the chi-square goodness-of-fit test processing unit calculates the chi-square goodness-of-fit test statistic by using the histogram of the inspection product after the gain correction and the histogram of the normal product after the gain correction.

10. The predictive maintenance device according to claim 2,
wherein the chi-square goodness-of-fit test processing unit performs gain correction of reducing a frequency on a low power side or a low amplitude side and increasing a frequency on a high power side or a high amplitude side in the histograms of the inspection product and the normal product, and
the chi-square goodness-of-fit test processing unit calculates the chi-square goodness-of-fit test statistic by using the histogram of the inspection product after the gain correction and the histogram of the normal product after the gain correction.

11. A predictive maintenance method of detecting an abnormality sign of a target unit to be monitored forming a part of an apparatus, the predictive maintenance method comprising:
a time waveform data acquisition step of acquiring time waveform data of a current or a voltage of the target unit during operation, which is measured by a measurement circuit;
an FFT step of performing Fourier transform on the time waveform data to obtain a spectrum of the time waveform data;
a disturbance removal step of obtaining a disturbance-removed waveform by removing an effect of a disturbance from any of the spectrum, a logarithmic spectrum of the spectrum, a cepstrum of the logarithmic spectrum, and a logarithmic cepstrum of the cepstrum;
a histogram creation step of creating a histogram of power or an amplitude of the disturbance-removed waveform;
a chi-square goodness-of-fit test processing step of calculating a chi-square goodness-of-fit test statistic between the histogram obtained from an inspection product that is the target unit having a possibility of an abnormality and the histogram obtained from a normal product that is the normal target unit; and
an abnormality determination step of determining whether or not the target unit as the inspection product is abnormal based on a P value corresponding to the chi-square goodness-of-fit test statistic.

12. The predictive maintenance method according to claim 11, further comprising:
a section division step of calculating a plurality of peak frequencies or peak times of a plurality of quefrencies according to an operation state of the target unit in the disturbance-removed waveform, and dividing the disturbance-removed waveform with a plurality of frequency sections or a plurality of time sections each including each of the peak frequencies or each of the peak times,
wherein in the histogram creation step, the histogram of the disturbance-removed waveform is created for each of the frequency sections or the time sections.

13. The predictive maintenance method according to claim 11,
wherein in the disturbance removal step, the disturbance-removed waveform is obtained by dividing a value of power or an amplitude of the spectrum by an integral value related to a frequency of the spectrum.

14. The predictive maintenance method according to claim 11,
wherein in the disturbance removal step, the disturbance-removed waveform is obtained by dividing a value of power or an amplitude of the cepstrum by an integral value related to a time of the cepstrum.

15. The predictive maintenance method according to claim 11,
wherein in the disturbance removal step, the disturbance-removed waveform is obtained by subtracting a direct current component corresponding to a 0-th component of the cepstrum from the logarithmic spectrum.

16. The predictive maintenance method according to claim 11,
wherein in the chi-square goodness-of-fit test processing step, gain correction of reducing a frequency on a low power side or a low amplitude side and increasing a frequency on a high power side or a high amplitude side in the histograms of the inspection product and the normal product is performed, and
the chi-square goodness-of-fit test processing step, the chi-square goodness-of-fit test statistic is calculated by using the histogram of the inspection product after the gain correction and the histogram of the normal product after the gain correction.
